(19) United States
(12) Patent Application Publication
(10) Pub. No.: US 2025/0219790 A1
(43) Pub. Date: Jul. 3, 2025

(54) METHOD FOR COMMUNICATION IN A MULTI-TRANSMISSION/RECEPTION POINT SYSTEM

(71) Applicants: CENTRE OF EXCELLENCE IN WIRELESS TECHNOLOGY, Taramani, Chennai (IN); INDIAN INSTITUTE OF TECHNOLOGY MADRAS (IIT MADRAS), Chennai (IN)

(72) Inventors: Vishakha SINGH, Taramani, Chennai (IN); Thirunageswaram Ramachandran RAMYA, Taramani, Chennai (IN); Dhivagar BASKARAN, Taramani, Chennai (IN); Jeniston Deviraj Klutto MILLETH, Taramani, Chennai (IN); Bhaskar RAMAMURTHI, Adyar, Chennai (IN)

(21) Appl. No.: 18/845,722

(22) PCT Filed: Mar. 10, 2023
(86) PCT No.: PCT/IN2023/050231

§ 371 Date: Sep. 10, 2024

(30) Foreign Application Priority Data
Mar. 10, 2022 (IN) 202241013148

(51) Int. Cl. H04L 5/00; H04B 7/06; H04W 72/231; H04W 76/27

(52) U.S. Cl. CPC H04L 5/0053; H04B 7/06968; H04W 72/231; H04W 76/27

(57) ABSTRACT

The present invention relates to various signaling methods associated with a multi-transmission reception point (TRP) system. A method of indicating transmission configuration indicator (TCI) state(s) of operation for a user equipment (UE) in a telecommunication network is proposed. The method comprises receiving a media access control-control element (MAC-CE) structure. The MAC-CE structure comprises a code-point mapped to a TCI state. The TCI state is at least one of joint downlink (DL) TCI state and uplink (UL) state and at least one of joint/DL TCI state, and UL state. A downlink control information (DCI) is received. The DCI comprises a TCI field indicating a code-point of the MAC-CE structure and a flag for selection of one of joint TCI state of operation for DL and UL and separate TCI states of operation one for DL and one for UL. The TCI state is activated, based on the flag and the TCI field. The UE is operated in the at least one TCI state. Further, a method of indicating a TCI state using a group common DCI is proposed. Furthermore, a method as transmitting a hybrid automatic repeat request (HARQ) from the group of UEs using a group common physical uplink control channel (PUCCH) is proposed. Furthermore, methods for handling collisions between difference channels and signals in a M-TRP system are proposed. In the event of a collision, a signal/channel is chosen based on preconfigured rules. Additionally, methods of activating and updating TCI states for different channels in a M-TRP system are proposed. Further, methods of associating a TCI state are proposed.

### FIELD OF THE INVENTION

The present disclosure relates generally to multi-Transmission/Reception Point (TRP) system, and more particularly, to methods of communication between user equipment and base stations in multi-TRP system.

### BACKGROUND OF THE INVENTION

Fifth Generation (5G) wireless networks support massive connectivity, high capacity, ultra-reliability, and low latency services. Such diverse use case scenarios require multiple approaches for the realization of future 5G systems. The Rel-15 New Radio (NR) includes several Multiple-Input Multiple-Output (MIMO) features that facilitate utilization of a large number of antenna elements at base station for both sub-6 GHz and over-6 GHz frequency bands. The Rel-16 NR extended the features of Rel-15 by introducing support for Multi-Transmission/Reception Point (TRP) transmission especially for enhanced mobile broadband (eMBB) and Physical Downlink Shared Channel (PDSCH), enhancements for multi-beam operation including reduction in latency and/or overhead for various reconfigurations.

The idea of quasi-co-location (QCL) was introduced in Fourth Generation (4G). As per the 3rd Generation Partnership Project (3GPP), two reference signals (RSs) can have a QCL relationship, where two antenna ports are said to be QLCed if properties of the channel over which a symbol on one antenna port is conveyed can be inferred from the channel over which a symbol on the other antenna port is conveyed. Two RSs are said to be QCLed if the large-scale channel properties of one RS can be inferred from other RS. There are various QCL types depending on the large-scale parameter common between the QCLed RS signals. QCL helps a User Equipment (UE) to infer the channel conditions of one RS based on the channel conditions of the other (QCLed) RS. The QCL relationship is configured by the higher layer parameter qcl-Type1 for the first Downlink (DL) RS, and qcl-Type2 for the second DL RS. With requirement for advanced beam management and introduction of features such as multi-TRP, it is essential to have multiple potential QCL configurations and select one QCL based on a requirement.

A plurality of Transmission Configuration Indicator (TCI) states is introduced in NR to enable multiple configurations of QCL relation between RSs. Each TCI state of the plurality of TCI states comprises information of a source RS, target RS, and the QCL relation (QCL Type) between RSs.

Three different configuration mechanisms are used to associate a TCI state to a target RS. A first configuration mechanism is usage of Radio Resource Control (RRC) message for periodic Channel State Information Reference Signal (CSI-RS). A second configuration mechanism is usage of MAC Control Element (MAC-CE) for Physical Downlink Control Channel Demodulation Reference Signal (PDCCH DM-RS) or Semi-persistent (SP) CSI-RS. A third configuration mechanism is usage of Downlink Control Information (DCI) for PDSCH DM-RS and for aperiodic CSI-RS.

A default QCL relation exists between PDCCH DM-RS, PDSCH DM-RS, and the Synchronization Signal Block (SSB) before RRC configuration of the plurality of TCI states. The default QCL relation is used in the initial access procedure. A maximum of 128 TCI states are configured to the UE, through RRC. A periodic CSI-RS used for CSI acquisition is directly associated with a TCI state (i.e., configured by RRC). For PDCCH DM-RS, MAC-CE is used to select and activate one of the RRC configured TCI states for the Control Resource Set (CORESET) used by the PDCCH. For PDSCH DM-RS, MAC-CE is used to select and activate code point of the TCI states for PDSCH DM-RS, either a single TCI state or up to eight TCI states, from the list of RRC configured TCI states. In the case of PDSCH DM-RS, a scheduling DCI selects one of the eight activated TCI states for PDSCH DM-RS. It is also possible to configure PDSCH DM-RS using the same TCI state as the PDCCH that scheduled the PDSCH (i.e., same beam is used for PDCCH and PDSCH).

To enable the BS to prepare a good receive (RX) beam that corresponds to the UE transmission, there is a functionality referred to as spatial relation. A spatial relation is different from a QCL relation, where spatial relation is defined on the UE side while QCL is defined on the BS side (as observed at the UE). Hence, similar to configuring QCL relations by TCI states for the DL transmissions, a plurality of spatial relations is configured for the UL transmissions. For UL, the spatialRelationInfo is used for beam indication for Physical Uplink Control Channel (PUCCH) and Sounding Reference Signal (SRS). The spatialRelationInfo is updated through RRC and MAC-CE signalling. For Physical Uplink Shared Channel (PUSCH), a SRS Resource Indicator (SRI) is signalled in DCI with UL grants and is used for beam indication.

Rel.15/16 beam management is severely deficient for supporting high (inter and intra-cell) mobility pertinent to FR2 operators as well as scenarios requiring large number of configured TCI states. Thus, complexity, overhead, and latency of beam management are increased due to different beam indication or update mechanisms. Such drawbacks are especially troublesome for high mobility scenarios (such as highway/vehicular and high-speed train (HST) operations at FR2). Therefore, in Rel-17 NR, a unified TCI framework was introduced for further reduction in overhead and latency for high intra-/inter-cell mobility and large number of configured TCI states with high efficiency. In the unified TCI framework, a Base Station (BS) supports L1-based beam indication (TCI update) to enable common beam for DL data and control and common beam for UL data and control transmission. There are two types of the unified TCI framework defined based on the condition of existence of beam correspondence between DL and UL. A first type of the unified TCI framework specifies a joint (common) TCI state to the UE for DL reception and UL transmission when beam correspondence between DL and UL is assumed. A second type of the unified TCI framework specifies separate TCI states for DL reception and UL transmission when beam correspondence is not assumed.

Along with unified TCI feature, support of M-TRP transmission was also extended to other channels in Rel-17 NR such as PDCCH, PDSCH, PUCCH, and PUSCH. The benefit of lower signalling overhead and latency using the unified TCI framework is achieved in multi-TRP transmission. There are different requirements for data and control channel to support the unified TCI framework in multi-TRP transmission.

In some scenarios such as high mobility scenarios or when a UE changes its panel dynamically that is being used for DL and UL, the beam correspondence also changes dynamically. In these scenarios, to cope-up with the dynamically changing beam correspondence, the provision to dynamically switch between joint and separate operation is required. Currently in Rel-17 NR, there is no provision for the UE to switch between joint and separate TCI operation.

When multiple UEs exhibit a common mobility behavior e.g., UEs in a public bus or in high-speed train, generally, all the UEs are served by the same set of beams. If BS signals unified TCI state for all the UEs independently via. DCI, it results in very high signalling overhead. To reduce overhead, a method in which BS signals a group of UEs, their respective unified TCI states using a single DCI i.e., a group-common DCI is required.

In Rel-17 NR specification, when the UE receives a DCI comprising a unified TCI state, the UE sends the corresponding acknowledgement to the BS for indicating the successful reception of the DCI. When BS schedules the group of UEs with same beam or different beam using group common PDCCH, containing the unified TCI state indication for a group of UEs, then there is a requirement of group common PUCCH for a group of UEs to reduce the overhead and latency at the BS. For receiving acknowledgement from all the scheduled UEs combined, a group common PUCCH framework is required.

Release 16 extends NR with the support for downlink multi-TRP transmission. For example, release 16 has a provision to transmit PDSCH simultaneously from two geographically separated TRPs. The two geographically separated TRPs may, for example, correspond to different physical cell sites but from a device point-of-view the multi-point transmission will still be considered originating from a single logical cell. There are several potential advantages with the multi-TRP transmission. It can be used to extend the overall transmission power available for downlink transmission to a single device by utilizing the total power available at multiple transmission points and can also be used to extend the overall rank of the channel when the rank from a single transmission point is limited, for example, due to line-of-sight propagation conditions. In 3GPP Rel-15/Rel-16, the scheme for beam indication is designed independently for each channel/RS. For PDCCH and PUCCH, MAC-CE activates a TCI state/spatial relation from the candidate TCI states/spatial relations configured by RRC. For PDSCH, the BS indicates the TCI state through DCI, where the selected TCI state is from a group of TCI states activated by MAC-CE. For PUSCH, SRI field in DCI is used to indicate the spatial relation. For CSI-RS/SRS, TCI state/spatial relation is configured by RRC or activated by MAC-CE or indicated by DCI. To reduce the signaling overhead of beam indication in Rel 17 for single TRP, a unified TCI framework is required, in which the single common beam is used to indicate the beam for different data/channels/RSs.

As per Rel-15/16 specification, if a UE is configured to monitor time overlapping CORESETs with different spatial receiver filters, the UE selects one among the multiple overlapping CORESETs according to the specification and looks for PDCCH in all the CORESETs that has the same spatial receiver setting as the selected CORESET. The selected CORESET is the CORESET corresponding to a Combined Search Space (CSS) set with a lowest index in the cell with the lowest index containing the CSS. Alternately, to the USS set with the lowest index in the cell with lowest index. The lowest USS set index is determined over all USS sets with at least one PDCCH candidate in overlapping PDCCH monitoring occasions.

In Rel-17 NR, enhancements have been made for improving reliability of PDCCH in M-TRP scenario by repeating the PDCCH from all the TRPs. This is achieved by linking the search space sets in which the PDCCHs that are being repeated and each of these linked search space sets mapped to a unique CORESET.

When the UE is configured with M-TRP operation, there would be situations where channel characteristics from one TRP changes, while the channel characteristics from another TRP remains unchanged. This leads to a requirement for the BS to change/update only one out of the two activated TCI states for M-TRP operation.

In Rel-16 NR, if the UE is configured for M-TRP operation, BS configures the UE with up to 128 TCI states and signals the UE with a MAC-CE that consists of up to eight code points where each code point maps to one or two TCI states out of the configured TCI states. BS signals one out of the eight code points (from MAC-CE) using a DCI to the UE activating the corresponding TCI state(s).

In Rel-17 NR, the UE is configured with up to 128 unified TCI states for joint/DL TCI state indication and 64 TCI states for UL TCI state indication. Further, the BS signals a MAC-CE to the UE that consists of up to eight code points where each code point maps to either one joint TCI state in case of a UE configured with joint unified TCI operation or one DL TCI state and one UL TCI state in case of a UE configured with separate unified TCI operation.

When a Multi-TRP architecture is combined with unified TCI framework, the BS needs to signal the unified TCI state using DCI for UL and DL data/channel/RS for each TRP in case of separate and joint TCI indication to the UE. To signal the Common TCI state to a UE using DCI for each TRP for both the cases of separate TCI and joint TCI operation, codepoints in MAC-CE should map to four TCI states which is not defined in existing Rel 17.MAC-CE structures.

A MAC-CE structure in which each code point maps to up to four TCI states for both the separate and joint TCI operation is thus required.

In Rel-15/16 NR, each CORESET is configured with up to 64 TCI states and BS signals a UE to activate one out of these 64 TCI states using a MAC-CE. When a UE monitors a search space set associated with a CORESET, the UE uses the activated TCI state for that corresponding CORESET. In Rel-17 NR, if a UE is configured with a set of 128 unified TCI states, one of these TCI states is activated using a DCI for a UE. When a UE monitors any search space set, UE uses the activated unified TCI state to receive the CORESET.

In Rel-16 NR, there are various M-TRP schemes that are introduced by 3GPP. In the case of a multi-TRP scenario, the transmission and reception to and from different TRPs can be multiplexed in one of time, frequency, and space, leading to FDM Scheme A, FDM scheme B, TDM scheme A, and SDM scheme. To support the various M-TRP schemes, 3GPP introduced various new parameters configured for the UE. One among these parameters is a CORESETPoolIndex. A CORESET pool index is a variable that will be present in the ControlResourceSet IE (information element). This variable can take a value of either 0 or 1. If this variable is not configured for a CORESET, UE assumes default value that is 0 for that CORESET. When a UE is configured by higher layer parameter PDCCH-Config that contains two different values of CORESETPoolIndex in ControlResourceSet IE, the UE may expect to receive multiple PDCCHs scheduling fully/partially/non-overlapped PDSCHs in time and frequency domain. Similarly, when a UE is configured with 0 CORESETPoolIndex by higher layer parameter then the UE may expect to schedule with full/partially/non-overlapped PDSCHs in time and frequency domain, the full scheduling information for receiving a PDSCH is indicated and carried only by the corresponding PDCCH. Thus, determining the TCI state for PDSCH based on configured CORESET pool index in different scenarios is required.

Further, assuming that panels are located at different positions, for example, back-to-back, UE may not be able to determine its transmission beam on one panel for uplink transmission based on downlink measurement on the other panel, and vice versa, even it could do so for the same panel. To address this issue, associations between DL beams on one panel and UL beams on the other panel is required.

Thus, there is a need of a method for performing communication in multi-TRP system, which addresses the above-mentioned shortcomings of conventional methods.

### OBJECTS OF THE INVENTION

A general objective of the present invention is to provide methods for performing communication in multi-TRP system.

Another objective of the present invention is to extend the current M-TRP specification of NR to support unified Transmission Configuration Indicator (TCI) framework.

Another objective of the present invention is to provide methods for dynamically switching between joint and separate operation.

Another objective of the present invention is to indicate TCI state of operation for a User Equipment (UE) in the multi-TRP system.

Another objective of the present invention is to determine a Control Resource Set (CORESET) and a search space set for monitoring Physical Downlink Control Channel (PDCCH) in multi-TRP system.

Another objective of the present invention is to receive a Physical Downlink Shared Channel (PDSCH) and a Physical Downlink Control Channel (PDCCH) in the multi-TRP system.

Another objective of the present invention is to receive a PDSCH and a reference signal in the multi-TRP system.

Another objective of the present invention is to receive a reference signal in multi-TRP system.

Another objective of the present invention is to update a TCI state of a UE in a multi-TRP system.

Still another objective of the present invention is to determine a unified TCI state for monitoring a CORESET in a Multi-TRP system.

Yet another objective of the present invention is to determine a unified TCI state of a PDSCH in a Multi-TRP system.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

The present invention relates to a method of indicating transmission configuration indicator (TCI) state of operation for a user equipment (UE) in a telecommunication network. The method comprises receiving at least one medium access control-control element (MAC-CE) structure. The at least one MAC-CE structure comprises at least one code-point mapped to at least one TCI state from a plurality of the TCI states. The plurality of the TCI states is one of at least one of joint TCI state, downlink (DL) TCI state, uplink (UL) state and at least one of joint/DL TCI state, and UL state. The method further comprises receiving a downlink control information (DCI), wherein the DCI comprises a TCI field indicating a code-point of the at least one MAC-CE structure and a flag for selection of one of joint TCI state of operation for both DL and UL and separate TCI states of operation one for DL and one for UL. The flag comprises at least one bit. The method further comprises activating the at least one TCI state from the plurality of TCI states, based on the flag and the TCI field. The method further comprises activating the at least one TCI state from the plurality of TCI states, based on the flag and the TCI field. The method further comprises operating by the UE in the at least one TCI state.

In an aspect, the at least one MAC-CE structure comprises at least one of bandwidth part (BWP) identity (ID), serving cell ID, and a code-point.

In an aspect, at least one code-point is mapped to at least one TCI state.

In an aspect, the at least one code-point is mapped to the at least one TCI state from at least one of joint/DL TCI states, joint TCI states, DL TCI states, and UL TCI states.

In an aspect, the at least one code-point of the at least one MAC-CE structure is mapped to the at least one of one TCI state and two TCI states.

In an aspect, the at least one MAC-CE structure indicates at least one of the joint TCI state operation and the separate TCI state operation.

In an aspect, the at least one code-point in the at least one MAC-CE structure is mapped to the at least one TCI state from at least one of joint/DL TCI states and UL TCI states.

The present invention further describes a method of indicating transmission configuration indicator (TCI) state operation for a user equipment (UE) in a telecommunication network. The method comprises receiving a medium access control-control element (MAC-CE) structure comprising at least one of bandwidth part (BWP) identity (ID), serving cell ID, at least one code-point. The at least one code-point is mapped to at least one TCI state from the plurality of TCI states, and a flag for selection of one of joint TCI state of operation for both Downlink (DL) and Uplink (UL), and separate TCI states of operation one for DL and one for UL, wherein flag comprises at least one bit. The method further comprises receiving a downlink control information (DCI) comprising a TCI field. The TCI field indicates the at least one code-point of the MAC-CE structure. The method further comprises activating the at least one TCI state from the plurality of TCI states based on the flag in the MAC-CE structure and the TCI field of the DCI. The method further comprises operating by the UE in the at least one TCI state.

In an aspect, the plurality of the TCI states is at least one of joint/DL TCI state and UL state.

In an aspect, the at least one code-point is mapped to the at least one TCI state from at least one of joint/DL TCI states and UL TCI states.

The present invention further describes a method of communication in a telecommunication network. The method comprises transmitting, by a base station (BS), a group-common downlink control information (DCI) to an at least one user equipment (UE) from a plurality of UEs. The group-common DCI comprises at least one transmission configuration indicator (TCI) state corresponding to the at least one UE and a scheduling information for a group-common physical uplink control channel (PUCCH). The method further comprises receiving by the BS, a hybrid automatic repeat request (HARQ) indicating the status of reception of the group-common DCI from the at least one UE in the group common PUCCH.

In an aspect, the at least one TCI state in the group-common DCI is used by the at least one UE for at least one of transmission and reception.

In an aspect, transmitting by the BS, further comprises configuring a common radio network temporary identifier (RNTI) to the at least one UE for receiving the group-common DCI.

In an aspect, the at least one TCI state is indicated in the group-common DCI using a bit field from the plurality of bit fields to indicate the at least one TCI state for the at least one UE. The position of the bit field of the at least one UE is configured by the BS.

In an aspect, the at least one TCI state is configured by the BS from a plurality of TCI states of the at least one UE.

In an aspect, the at least one TCI state is configured by the BS from a plurality of TCI states of the at least one UEs. The plurality of the TCI states of the at least one UE is preconfigured with at least one common TCI state.

In an aspect, the scheduling information comprises a timing offset indicating a slot index and a PUCCH resource indicator for the group-common PUCCH.

In an aspect, the PUCCH resource indicator indicates at least one of time domain resource allocation, frequency domain resource allocation, a modulation order, and a coding rate of the group-common PUCCH.

In an aspect, the HARQ of the at least one UE is received in a subset of resources allocated for the group-common PUCCH.

In an aspect, the subset of resources of the at least one UE are multiplexed in at least one of time domain, frequency domain, spatial domain, and code domain.

In an aspect, the HARQ of the at least one UE is indicated using at least one bit.

In an aspect, the at least one UE encodes and modulates the at least one bit to obtain modulated symbols.

In an aspect, the modulated symbols are multiplied with a preconfigured sequence.

In an aspect, the at least one UE maps the at least one bit to a preconfigured sequence.

The present invention further describes a method of determining at least one control resource set (CORESET) and at least one search space set for monitoring physical downlink control channel (PDCCH) in multi-transmission/reception point (TRP) system. The method comprises receiving a configuration information from a base station (BS) by at least one UE to monitor, an at least one PDCCH in a plurality of CORESETs configured with different quasi-co-location (QCL) properties and a plurality of search space sets associated with at least one CORESET from the plurality of CORESETs, at the same time instant. The at least one search space set of the plurality of search space sets is linked with PDCCH repetition. The method further comprises determining, by the at least one UE, a first CORESET from the plurality of CORESETs. The method further comprises determining, by the at least one UE, an at least one second CORESET based on the QCL properties of the first CORESET. The method further comprises monitoring, by the at least one UE, the at least one PDCCH in the at least one search space set associated with the first CORESET. The method further comprises monitoring, by the at least one UE, the at least one PDCCH in the at least one search space set associated with at least one second CORESET.

In an aspect, the first CORESET is associated with one of a combined search space (CSS) and unified search space (USS) of lowest index.

In an aspect, the first CORESET is associated with one of a CSS and USS of lowest index configured with the PDCCH repetition.

In an aspect, the first CORESET is associated with one of a CSS and a USS of lowest Identity (ID) configured with spatial receive parameters in the QCL properties.

In an aspect, the first CORESET is associated with one of a CSS and a USS of lowest ID configured with spatial receive parameters in the QCL properties and for the PDCCH repetition.

In an aspect, the QCL properties comprise at least one of a delay spread, a doppler spread, an average delay, a doppler shift, an average gain, and spatial receive parameters.

In an aspect, the QCL properties are configured for the plurality of CORESETs belonging to a unified TCI state.

The present invention further describes a method of receiving at least one of at least one physical downlink shared channel (PDSCH) and at least one physical downlink control channel (PDCCH) in multi-transmission/reception point (TRP) system. The method comprises receiving, by at least one user equipment (UE), a configuration information from a base station (BS) to monitor PDCCH in a plurality of control resource sets CORESETs configured with quasi-co-location (QCL) properties. The method further comprises receiving, by at least one UE, a scheduling information from the BS for at least one PDSCH and corresponding QCL properties. The method further comprises determining, by the at least one UE, at least one CORESET to monitor and at least one scheduled PDSCH are overlapping one of fully and partially in time and has different QCL properties. The method further comprises determining, by the at least one UE, to perform at least one of PDCCH monitoring in at least one CORESET and receive at least one PDSCH based on preconfigured rules.

In an aspect, the preconfigured rules specify the at least one UE to perform PDCCH monitoring in the at least one CORESET and drop the at least one PDSCH.

In an aspect, the preconfigured rules specify the at least one UE to receive the at least one PDSCH and skip PDCCH monitoring in the at least one CORESET.

In an aspect, the preconfigured rules specify the at least one UE to perform PDCCH monitoring in the at least one CORESET and to receive the at least one PDSCH in symbols not overlapping with the at least one CORESET.

The present invention further describes a method of receiving at least one physical downlink shared channel (PDSCH) and at least one reference signal (RS) in multi-transmission/reception point (TRP) system. The method comprises receiving a configuration information by at least one user equipment (UE) to receive at least one RS configured with quasi-co-location (QCL) properties. The method further comprises receiving, by the at least one UE, from a base station (BS), scheduling information for at least one PDSCH, indicating the corresponding QCL properties. The method further comprises determining, by the at least one UE, that the at least one RS and the at least one PDSCH are overlapping one of fully and partially in time with different QCL properties. The method further comprises receiving, by the at least one UE, at least one of the at least one RS and the at least one PDSCH based on preconfigured rules.

In an aspect, the preconfigured rules specify the at least one UE to receive the at least one RS and drop the at least one PDSCH.

In an aspect, the preconfigured rules specify the at least one UE to receive the at least one PDSCH and drop the at least one RS.

In an aspect, the preconfigured rules specify the at least one UE to receive the at least one RS and to receive the at least one PDSCH in the symbols not overlapping with the at least one RS.

The present invention further describes a method of receiving at least one reference signal (RS) in multi-transmission/reception point (TRP) system. The method comprises receiving a configuration information by at least one user equipment (UE) to receive a plurality of RSs configured with quasi-co-location (QCL) properties. The method further comprises receiving, by the at least one UE, a preconfigured priority corresponding to each RS from the plurality of RSs. The method further comprises determining, by the at least one UE, that at least one first RS and at least one second RS of the plurality of RSs are overlapping one of fully and partially in time with different QCL properties. The method further comprises receiving, by the at least one UE, the at least one first RS and the at least one second RS based on the preconfigured priority of the corresponding RS.

In an aspect, the at least one RS is channel state information RS (CSI-RS).

In an aspect, a priority of CSI-RS used for beam management is higher than a priority of CSI-RS used for CSI measurement.

The present invention further describes a method of updating at least one transmission configuration indicator (TCI) state of at least one user equipment (UE) in a multi-transmission/reception point (TRP) system. The method comprises transmitting, by a base station (BS), configuration information associated with a plurality of TCI states to at least one UE, wherein the configuration information comprises a TCI pool index corresponding to the plurality of TCI states. The method further comprises signaling, by the BS to the at least one UE, at least one set of TCI states from the pre-configured list of TCI states. The method further comprises performing, by the at least one UE, at least one of transmission and reception using the at least one set of TCI states. The method further comprises signaling, by the BS, to obtain an updated TCI states by replacing the at least one TCI state with at least one another TCI state, wherein the at least one TCI state is replaced based on the TCI pool index of the at least one another TCI state.

In an aspect, the method further comprises performing, by the at least one UE, at least one of transmission and reception using the updated TCI states.

In an aspect, the configuration information is signalled using at least one of radio resource control (RRC) and medium access control-control element (MAC-CE) based signalling.

In an aspect, a value of the TCI pool index ranges from 0 to n−1, and wherein ‘n’ indicates a number of TRPs connected with the at least one UE.

In an aspect, the at least one set of TCI states is a pair of TCI states indicated to the UE for at least one of transmission and reception.

In an aspect, the at least one UE updates the at least one TCI state by replacing the at least one TCI state in the at least one set of TCI states belonging to the same TCI pool index as the at least one another TCI state.

In an aspect, the at least one TCI state comprises at least one quasi-co-location (QCL) property, wherein the at least one QCL property includes at least one of a delay spread, a doppler spread, an average delay, a doppler shift, an average gain, and spatial receiver parameters.

In an aspect, the at least one TCI state is signalled using a downlink control information (DCI).

In an aspect, the at least one TCI state belongs to a unified TCI state.

The present invention further describes a method of receiving an at least one transmission configuration indicator (TCI) state for operation of at least one user equipment (UE) in a multi-transmission/reception point (TRP) system. The method comprises receiving a medium access control-control element (MAC-CE) structure comprising at least one code-point, wherein the at least one code-point is mapped to at least one TCI state from a plurality of TCI states of at least one TRP from the plurality of the TRPs, wherein the plurality of the TCI states is at least one of joint/DL TCI states and UL states. The method further comprises receiving a downlink control information (DCI), wherein the DCI comprises a TCI field indicating one of the code-points from the MAC-CE structure. The method further comprises activating at least one TCI state using the at least one code-point. The method further comprises operating by the at least one UE in the at least one TCI state.

In an aspect, the at least one TCI state belongs to a unified TCI state.

In an aspect, the MAC-CE structure comprises at least one of a serving cell Identity (ID), a downlink (DL) bandwidth part (BWP) ID, an uplink (UL) BWP ID, Ci, joint/DL TCI state ID, Bij, UL TCI state ID, Dij, and a reserved bit, where Ci indicates whether the octet containing joint/DL TCI state ID_{i,2} is present in the MAC-CE structure, Bij indicates whether the octet containing UL TCI state ID_{i,j} is present in the MAC-CE structure, and Dij indicates whether UE should consider the preceding octet as padding or as DL TCI state.

The present invention further describes a method in a wireless communication system. The method comprises receiving, by at least one user equipment (UE) from a base station (BS), a configuration information associated with a plurality of transmission control indicator (TCI) states, wherein the configuration information comprises a panel index corresponding to the plurality of TCI states. The method further comprises receiving, by the at least one UE, a panel ID from the configuration information, wherein the panel ID indicates position of an antenna panel from plurality of antenna panels of the at least one UE. The method further comprises beamforming, by the at least one UE, by activating the antenna panel for at least one of transmission and reception.

In an aspect, the configuration information is received by the at least one UE using at least one of radio resource control (RRC) signaling, medium access control-control element (MAC-CE), and downlink control information (DCI).

The present invention further describes a method of determining a unified transmission control indicator (TCI) state for monitoring a control resource set (CORESET) in a multi-transmission/reception point (TRP) system. The method comprises receiving, by at least one user equipment (UE), from a base station (BS), a configuration information associated with a plurality of unified TCI states and configuration information associated with a plurality of CORESETs, wherein each CORESET is associated with a CORESET pool index. The method further comprises receiving, by the at least one UE, the activation information of plurality of unified TCI states. The method further comprises determining, by the at least one UE, a unified TCI state from the plurality of TCI states for monitoring at least one CORESET of the plurality of CORESETs, based on associated CORESET pool index of the CORESET. The method further comprises receiving, by the at least one UE, an at least one physical downlink control channel (PDCCH) in the at least one CORESET using the determined unified TCI state.

In an aspect, the activation of the plurality of unified TCI states is signaled using at least one of medium access control-control element (MAC-CE) and downlink control information (DCI).

In an aspect, the plurality of CORESETs is divided into at least two sets, wherein the at least two sets are assigned to CORESET pool indices.

In an aspect, the BS activates ‘n’ number of unified TCI states for the at least one UE, wherein ‘n’ indicates a number of TRPs connected with the at least one UE.

In an aspect, the CORESET pool index ranges from 0 to n−1, wherein each CORESET pool index is associated with at least one TCI state of the plurality of activated TCI states.

In an aspect, the at least one UE determines the TCI state of CORESETs with a CORESET pool index, as an activated TCI state associated with the CORESET pool index.

In an aspect, the unified TCI state comprises a plurality of quasi-co-location (QCL) properties, and wherein the plurality of QCL properties include at least one of delay spread, doppler spread, average delay, doppler shift, average gain, and spatial receiver parameters.

The present invention further describes a method of determining a unified transmission control indicator (TCI) state for monitoring a control resource set (CORESET) in a multi-transmission/reception point (TRP) system. The method comprises receiving, by at least one user equipment (UE), a configuration information associated with a plurality of unified TCI states, wherein the configuration information comprises a TCI state index associated with at least one unified TCI state of the plurality of unified TCI states. The method further comprises receiving, by the at least one UE, a configuration information associated with a plurality of CORESETs, wherein the configuration information comprises a CORESET index associated with at least one CORESET of the plurality of CORESETs. The method further comprises receiving, by the at least one UE, a pre-defined mapping pattern. The method further comprises receiving by the at least one UE, activation of at least one TCI state of the plurality of TCI states from the BS. The method further comprises determining, by the at least one UE, index of a slot from which the at least one unified TCI state is activated. The method further comprises determining, by the at least one UE, a unified TCI state from the at least one unified TCI state for at least one CORESET, based on at least one of the CORESET index, the pre-defined mapping pattern, the slot index, and TCI state indices of the at least one unified TCI state. The method further comprises receiving, by the at least one UE, at least one physical downlink control channel (PDCCH) in the at least one CORESET using the unified TCI state.

In an aspect, the at least one UE determines the unified TCI state of at least one CORESET as the TCI state with one of a lowest and a highest TCI state index.

In an aspect, a slot is associated with the index of one of the integers from the sequence of integers in the pre-defined mapping pattern.

In an aspect, the pre-defined mapping pattern comprises a sequence of integers, wherein each integer of the sequence of integers is associated with corresponding a TCI state of the at least one TCI states.

In an aspect, the TCI state of the at least one CORESET in the slot is determined based on the TCI state associated with the integer of the sequence of integers associated with the slot.

In an aspect, the pre-defined mapping pattern is one of a sequential mapping pattern and a cyclic mapping pattern.

In an aspect, the at least one UE determines the TCI state of the at least one CORESET based on the CORESET index.

In an aspect, two TCI states are activated to the at least one UE, and the at least one UE determines the TCI state of the CORESETs with even and odd CORESET index from the at least one TCI state.

The present invention further describes a method of determining at least one unified transmission control indicator (TCI) state of at least one physical downlink shared channel (PDSCH) in a multi-transmission/reception point (TRP) system. The method comprises receiving, by the at least one user equipment (UE) from a Base Station (BS), a configuration information associated with a plurality of unified TCI states, wherein the configuration information comprises a TCI state index associated with the at least one unified TCI state of the plurality of TCI states. The method further comprises receiving, by the at least one UE from the BS, a configuration information associated with a plurality of control resource sets (CORESETs). The method further comprises receiving, by at least one UE from the BS using a downlink control information (DCI), at least one unified TCI state of the plurality of TCI states, wherein the at least one unified TCI state is associated with a TCI state Identity (ID). The method further comprises receiving, by the at least one UE from the BS, the scheduling DCI for the at least one PDSCH. The method further comprises determining, by the at least one UE, the at least one unified TCI state for receiving the at least one PDSCH based on a TCI state index of at least one unified TCI state and the associated TCI state ID of the at least one unified TCI states. The method further comprises receiving, by the at least one UE, the at least one PDSCH using the at least one unified TCI state.

In an aspect, the TCI state index is indicated to the at least one UE using radio resource control (RRC) message.

In an aspect, the method further comprises receiving, by the at least one UE, a second DCI indicating one unified TCI state. The method further comprises updating, by the at least one UE, at least one activated unified TCI states based on at least one of the unified TCI state in the second DCI and TCI state IDs of the activated unified TCI states in the first DCI.

In an aspect, the at least one UE determines one of using one of the unified TCI states and the plurality of unified TCI states from the at least one unified TCI state, for receiving the at least one PDSCH based on a field in the scheduling DCI.

In an aspect, the at least one UE determines one of using one unified TCI states and the plurality of unified TCI states from the at least one unified TCI state, for receiving the at least one PDSCH based on a number of code division multiplexing (CDM) groups present in the scheduling DCI.

In an aspect, the field in the scheduling DCI comprises at least one bit.

In an aspect, a scheduling DCI with only one CDM group indicates the at least one UE to use only one unified TCI state from the activated unified TCI states, for receiving the at least one PDSCH.

In an aspect, a scheduling DCI with a plurality of CDM groups indicates the at least one UE to use the plurality of unified TCI states from the activated unified TCI states, for receiving the at least one PDSCH.

In an aspect, the at least one UE determines a unified TCI state from the activated unified TCI states based on at least one of the TCI index of the activated unified TCI states and TCI IDs of the activated unified TCI states.

In an aspect, the at least one UE determines the unified TCI state with one of a lowest and a highest associated TCI IDs of the activated unified TCI states.

In an aspect, the at least one UE determines the unified TCI state with a one of lowest and highest TCI Index among the associated TCI indices of the activated unified TCI states.

In an aspect, the at least one UE updates the activated TCI states by activating the unified TCI state indicated by the second DCI and discarding the activated TCI states indicated by the first DCI.

In an aspect, the at least one UE updates the activated TCI states by replacing one of the activated TCI states indicated by the first DCI with the unified TCI state indicated by the second DCI, based on the associated TCI state IDs of the activated TCI states in the first DCI.

In an aspect, each of the activated TCI states indicated by the first DCI is associated with a TCI state ID in incremental order starting from ‘1’.

In an aspect, the configuration information associated with at least one CORESET from the plurality of CORESETs comprises a CORESET pool index.

In an aspect, the CORESET pool index of the plurality of CORESETs are same.

The present invention further describes a method of determining a unified transmission control indicator (TCI) state of at least one physical downlink shared channel (PDSCH) in a multi-transmission/reception point (TRP) system. The method comprises receiving, by at least one user equipment (UE) from a Base Station (BS), a configuration information associated with a plurality of unified TCI states, wherein the configuration information comprises a TCI state index associated with each unified TCI state. The method further comprises receiving, by at least one UE from the BS, a configuration information associated with a plurality of control resource sets (CORESETs), wherein the configuration information comprises at least one of CORESET index and a CORESET pool index associated with at least one of CORESET of the plurality of CORESETs, wherein the CORESET pool index is at least one of ‘0’ and ‘1’. The method further comprises receiving, by an at least one UE, an at least one downlink control information (DCI) from the BS for activating the two unified TCI states. The method further comprises activating, by the at least one UE, the two unified TCI states. The method further comprises mapping, by the at least one UE, the two activated unified TCI states to CORESET pool indices. The method further comprises receiving, by an at least one UE, an at least one scheduling DCI, from the BS, for at least one PDSCH. The method further comprises determining, by the at least one UE, at least one unified TCI state from the activated TCI states for receiving the at least one PDSCH based on a mapping rule between the unified TCI states and the CORESET pool indices. The method further comprises receiving, by the at least one UE, the at least one PDSCH using the at least one unified TCI state.

In an aspect, the at least one UE maps a first TCI state of the two activated TCI states to at least one of CORESET pool index of ‘0’ and CORESET pool index of ‘1’, a second TCI state of the two activated TCI states to an at least one of CORESET pool index of ‘1’ and CORESET pool index of ‘0’.

In an aspect, the at least one UE maps a first TCI state of the two activated TCI states to a CORESET pool index of the CORESET in which the DCI is scheduled and a second TCI state of the two activated TCI states to the other CORESET pool index.

The present invention further describes a method of determining a unified transmission control indicator (TCI) state of at least one physical downlink shared channel (PDSCH) in a multi-transmission/reception point (TRP) system. The method comprises receiving, by at least one user equipment (UE) from a base station (BS), a configuration information associated with a plurality of unified TCI states, wherein the configuration information comprises a TCI state index associated with each unified TCI state of the plurality of unified TCI states. The method further comprises receiving, by the at least one UE from the BS, a configuration information associated with a plurality of control resource sets (CORESETs), wherein the configuration information comprises at least one of a CORESET index and a CORESET pool index associated with each CORESET, wherein the CORESET pool index is at least one of ‘0’ and ‘1’. The method further comprises receiving by the at least one UE, an at least one downlink control information (DCI) from the BS for activating a unified TCI state of the plurality of unified TCI states, wherein the at least one DCI is scheduled in a CORESET with at least one of CORESET pool index of ‘0’ and ‘1’. The method further comprises activating, by the at least one UE, the unified TCI state. The method further comprises determining, by the at least one UE, at least one unified TCI state as the unified TCI state activated by the at least one DCI;
receiving by the at least one UE from the BS, at least one scheduling DCI, for at least one PDSCH. The method further comprises receiving, by the at least one UE, the at least one PDSCH using the determined at least one unified TCI state.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a first variation of the MAC-CE structure utilized in a Downlink Control Information (DCI) based signalling, in accordance with an embodiment of the present invention.

FIG. 2 illustrates a second variation of the MAC-CE structure utilized in the DCI based signalling, in accordance with an embodiment of the present invention.

FIG. 3 illustrates a third variation of the MAC-CE structure for a joint TCI state utilized in the DCI based signalling, in accordance with an embodiment of the present invention.

FIG. 4 illustrates a fourth variation of the MAC-CE structure for a separate TCI state utilized in the DCI based signalling, in accordance with an embodiment of the present invention.

FIG. 5 illustrates a MAC-CE structure for joint and separate TCI states utilized in MAC-CE based signalling, in accordance with an embodiment of the present invention.

FIG. 6 illustrates signalling formats utilized in a group common DCI method, in accordance with an embodiment of the present invention.

FIG. 7 illustrates a group common DCI and a group common PUCCH utilized in a Hybrid Automatic Repeat Request (HARQ) reporting method, in accordance with an embodiment of the present invention.

FIG. 8A illustrates a block diagram of separating UEs in TDM-FDM based method for group common PUCCH, in accordance with an embodiment of the present invention.

FIG. 8B illustrates a block diagram of separating UEs in CDM based method for group common PUCCH, in accordance with an embodiment of the present invention.

FIG. 9 illustrates a MAC-CE structure to support unified TCI framework for M-TRP operation, in accordance with an embodiment of the present invention.

FIG. 10 illustrates a TCI indication for single TRP and single DCI multi TRP, in accordance with an embodiment of the present invention.

FIG. 11 illustrates a TCI indication for single TRP, single DCI multi TRP, and multi DCI MTRP, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

A User Equipment (UE) may be configured to operate in either joint or separate Transmission Configuration Indicator (TCI) through Radio Resource Control (RRC) configuration. In joint TCI configuration, the UE may be signaled with a TCI state through a Downlink Control Information (DCI). The DCI may indicate quasi-co-location (QCL) information for all downlink (DL) and uplink (UL) channels and signals. In separate TCI configuration, the UE may be signaled with a pair of TCI states through the DCI. Each TCI state may provide the QCL information of DL and UL channels and signals separately. The UE may be configured with joint TCI when the UE has beam correspondence between DL and UL beams, or otherwise, the UE is configured with separate TCI.

The UE may be configured with two TCI state pools through the RRC configuration. A first TCI state pool of the two TCI state pools may comprise 128 TCI states. A plurality of TCI states may be selected from the first TCI state pool for the indication of joint TCI state, or the DL TCI state in case of separate TCI. A second TCI state pool of the two TCI state pools may comprise 64 TCI states. The TCI states may be selected from the second pool for UL TCI state indication, in case of separate TCI. If the UE is configured to operate in joint TCI, then a Base Station (BS) may activate up to eight TCI states using MAC-CE, out of 128 TCI states from the joint TCI state pool. Further, the BS may activate one out of the eight TCI states for UL transmission and DL reception using the DCI. If the UE is configured to operate in separate TCI, then the BS may activate up to eight pairs of TCI states using MAC-CE. Each pair of the eight pairs of TCI states may be mapped to a code-point in MAC-CE. A first TCI state of each pair may belong to the DL TCI state pool and a second TCI state of each pair may belong to UL TCI state pool. The BS may signal one of the eight code points using the DCI and the UE may activate the corresponding pair of TCI states for UL transmission or UL reception.

Dynamically switching between the joint operation and the separate operation may be performed using DCI based signalling or MAC-CE based signalling. In case of both the DCI based signaling and the MAC-CE based signaling, 128 TCI states may be configured by RRC and up to eight TCI states may be chosen from 128 TCI states using MAC-CE. A generic MAC-CE structure may comprise information on serving cell ID, BWP ID, and the TCI states for joint and separate TCI. The information in MAC-CE may be arranged in the form of octets and reserved bits ‘R’ are used to complete the octet on need basis.

In the DCI based signalling, an indication of joint or separate TCI may be provided to the UE using the DCI. The UE may utilize the DCI to dynamically adapt the TCI states. A flag with either one-bit flag or a group of bits may be used for the purpose of indication. The DCI based signalling may propose three variations in MAC-CE structures.

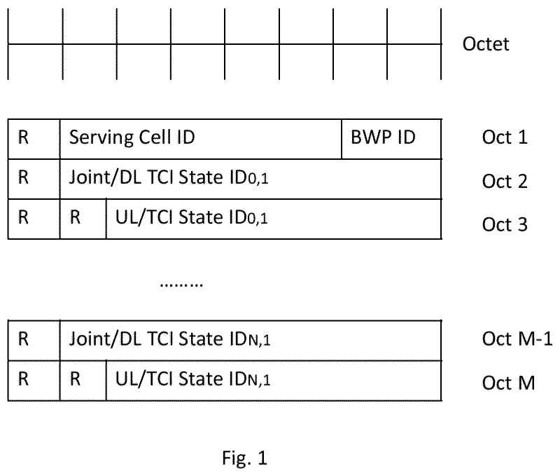

FIG. 1 illustrates a first variation of the MAC-CE structure utilized in the DCI based signalling, in accordance with an embodiment of the present invention. The MAC-CE may comprise up to eight code-points (octet). Each code-point of the eight code-point may be mapped to two TCI states. A first TCI state of the two TCI states may be from the joint/DL TCI state pool and a second TCI state may be from the UL TCI state pool. One out of the eight code-points may be selected and indicated to the UE through the DCI. The DCI may further comprise a flag that indicates whether joint or separate TCI state operation to be performed by the UE. The flag may be a one-bit flag or a group of bits flag. If the flag indicates joint TCI operation, the UE may activate the first TCI state out of the two TCI states indicated by the code-point for both UL transmission and DL reception. If the flag indicates separate TCI state operation, the UE may activate two TCI states indicated by the code-point for DL reception and UL transmission, respectively.

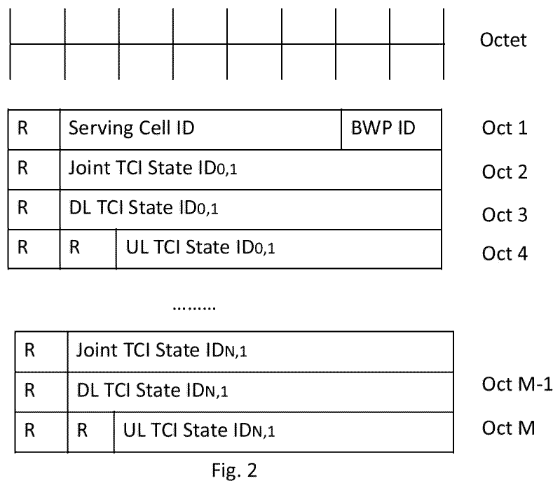

FIG. 2 illustrates a second variation of the MAC-CE structure utilized in the DCI based signalling, in accordance with an embodiment of the present invention. The MAC-CE may comprise up to eight code-points. Each code point of the eight code-points may be mapped to three TCI states. Among the three TCI states, a first TCI state and a second TCI state may belong to joint/DL TCI state pool and a third TCI state may belong to UL TCI state pool.

The UE may be signaled with one out of the eight code-points and a flag that indicates joint or separate TCI state operation through DCI. The flag may be a of one-bit flag or a group of bits. If the flag indicates the joint TCI operation, the UE may activate a first TCI state out of the two TCI states indicated by the code-point for UL transmission and DL reception. If the flag indicates separate TCI state operation, the UE may activate a second TCI state and a third TCI state indicated by the code-point for DL reception and UL transmission respectively.

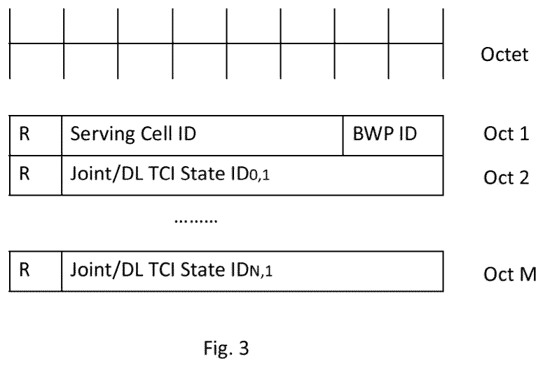

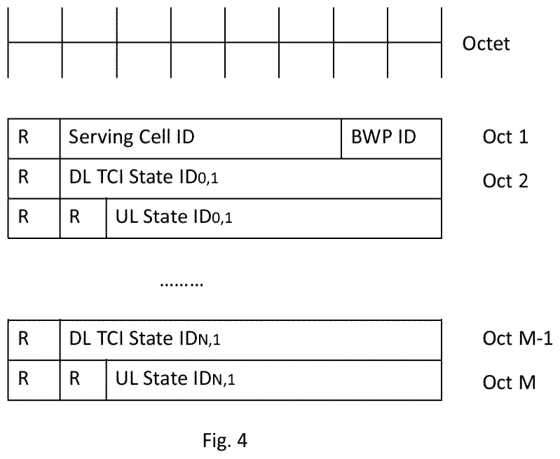

FIG. 3 illustrates a third variation of the MAC-CE structure for a joint TCI state utilized in the DCI based signalling, in accordance with an embodiment of the present invention. FIG. 4 illustrates the fourth variation of the MAC-CE structure for a separate TCI state utilized in the DCI based signalling, in accordance with an embodiment of the present invention. In the third variation, two MAC-CEs structures may be defined. A first MAC-CE structure may be defined for the joint TCI state and other for separate TCI state, respectively. The first MAC-CE and the second MAC-CE may be received by the UE. The UE may be signalled with one out of the eight code-points from MAC-CE and a flag that indicates joint or separate TCI state operation through the DCI. The flag may be of one-bit flag or a group of bits. If the flag indicates the joint TCI state operation, the UE may activate the TCI state corresponding to the indicated code-point of the MAC-CE defined for joint TCI state operation for UL transmission and DL reception. If the flag indicates separate TCI state operation, the UE may activate the pair of TCI states corresponding to the indicated code-point of the MAC-CE defined for separate TCI state operation for DL reception and UL transmission, respectively.

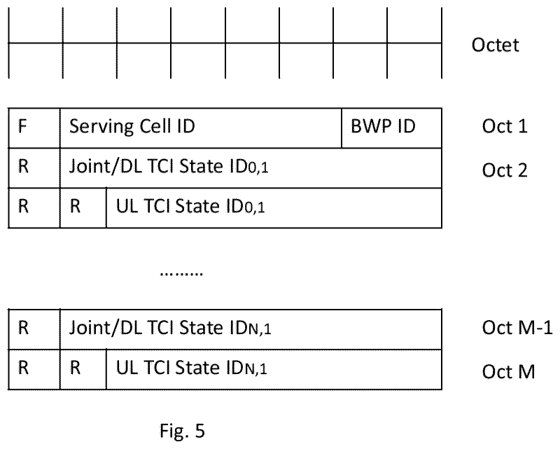

FIG. 5 illustrates a MAC-CE structure for joint and separate TCI states utilized in MAC-CE based signalling, in accordance with an embodiment of the present invention. In the MAC-CE based signalling, the indication of joint or separate TCI may be provided to the UE using MAC-CE. The UE may utilize the indication to adapt TCI states.

The UE may receive a MAC-CE having a one-bit flag ‘F’ indicating joint or separate TCI state operation. The flag may contain a group of bits. If the flag bit(s) indicates joint TCI state operation in the MAC-CE, each code-point of the MAC-CE may be mapped to one TCI state out of the 128 TCI states from joint/DL TCI state pool. If the flag bit(s) indicates separate TCI state operation, each code-point of the MAC-CE may be mapped to two TCI states. A first TCI state of the two TCI states may be from joint/DL TCI state pool and a second TCI state of the two TCI states may be from UL TCI state pool. Out of the eight code-points, the BS may activate one code-point using DCI. The UE activates the corresponding TCI states as indicated by the BS for DL reception and UL transmission.

To reduce overhead induced due to independent signalling of unified TCI states for a group of UEs exhibiting a common mobility behaviour, a method is provided for signalling the group of UEs. The BS may signal the group of UEs, their respective unified TCI states using a single DCI i.e., a group-common DCI. When the BS signals a group common DCI comprising unified TCI state indication for a group of UEs, the BS may also schedule the corresponding PUCCH in which the acknowledgements of all the UEs are carried. The PUCCH resource may be common for all the UEs and may be referred as a group common PUCCH.

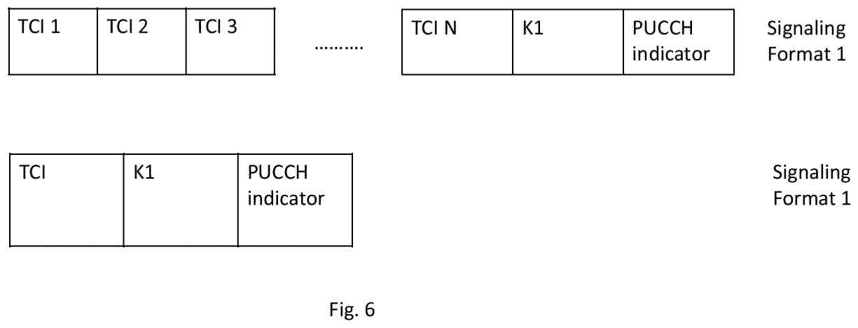

FIG. 6 illustrates signalling formats utilized in group common DCI method, in accordance with an embodiment of the present invention. The BS may configure a group of UEs for receiving the group common PDCCH by assigning a common RNTI for the group of UEs. The PDCCH may carry a DCI which contains unified TCI state for the group of UEs. The DCI may indicate a unique unified TCI states for each UE of the group of UEs as shown in signaling format 1 or may indicate a common unified TCI state applied to the group of UEs as shown in signaling format 2.

In the signaling format 1, TCI1, TCI2, and TCI N indicates the TCIs corresponding to UE1, UE2 and so on. The parameter K1 denotes the offset from the slot carrying PDSCH to slot carrying PUCCH and PUCCH indictor indicates the PRBs in which the PUCCH is scheduled. In the signaling format 1, where the DCI contains a unique unified TCI for each UE, bit field position of the respective unified TCI state of every UE and a dedicated unified TCI state pool for every UE are preconfigured by the BS. The UE may apply the respective unified TCI state indicated in the DCI associated with the dedicated TCI state pool for subsequent transmissions and receptions.

In the signaling format 2, the DCI may comprise a common TCI state for all UEs of the group of UEs. Each UE of the group of UEs may be preconfigured by the BS using a common unified TCI state pool. When a UE receives a group common DCI, the UE may apply the TCI state indicated by the DCI associated with the common TCI state pool for subsequent transmissions and receptions.

To reduce overhead induced due to independent signalling of unified TCI states for a group of UEs exhibiting a common mobility behaviour, a Hybrid Automatic Repeat Request (HARQ) reporting method is provided for signalling the group of UEs.

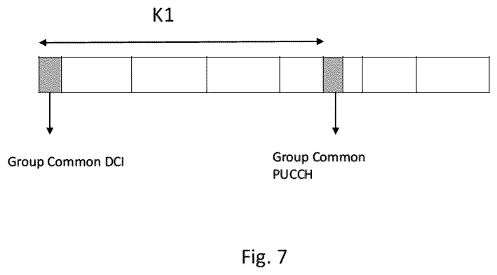

FIG. 7 illustrates a group common DCI, and a group common PUCCH utilized in the HARQ reporting method, in accordance with an embodiment of the present invention. The BS may schedule a common PUCCH for carrying the acknowledgements from all UEs in the group of UEs. The scheduling information of the common PUCCH for all UEs in the group of UEs may be present in the group common DCI. The scheduling information of PUCCH may comprise a slot offset indicating a slot index for the PUCCH and the symbols in the slot in which PUCCH is scheduled. The DCI may further comprise a PUCCH resource indicator indicating Physical Resource Blocks (PRBs) in which the PUCCH is scheduled, as illustrated in FIG. 7.

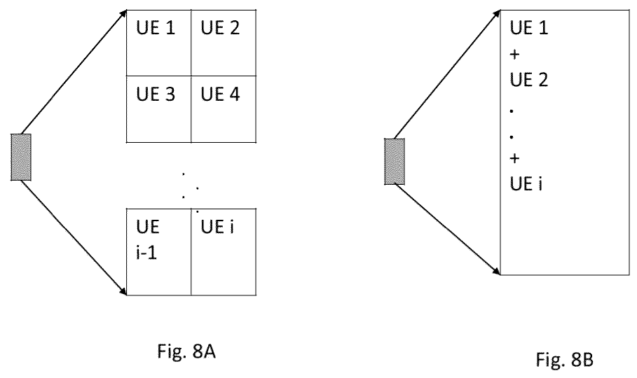

There are two ways in which the group common resources can be shared between the UEs in the group of UEs. FIG. 8A illustrates a block diagram of separating UEs in TDM-FDM based method for group common PUCCH, in accordance with an embodiment of the present invention. A time division multiplexing-frequency division multiplexing (TDM-FDM) sharing approach may be used for separating the UEs. A PUCCH resource indicator may indicate the UE of N PRBs. N PRBs may be divided into M sets of PRBs. Each set of the M sets may comprise N/M PRBs where M is the number of UEs that are scheduled to receive the group common PDCCH. As illustrated in the FIG. 8A, each UE may be uniquely associated with one out of the M sets of PRBs. After determining the PRBs associated with a UE, the UE may transmit the corresponding HARQ information in the determined PRBs.

There are two ways of transmitting HARQ using TDM-FDM sharing approach. In a first method of transmitting HARQ using TDM-FDM sharing approach, the UE may generate a one-bit information corresponding to positive or negative acknowledgement and may encode the information using a channel coder. Further, the UE may modulate the encoded bits using a predefined modulation scheme and transmits on the determined PRBs.

In a second method of transmitting HARQ using TDM-FDM sharing approach, the UE may generate a one-bit information corresponding to positive or negative acknowledgement and modulate it with a predefined modulation scheme and may multiply with an orthogonal sequence. The UE may further transmit the information on the predetermined PRBs.

FIG. 8B illustrates a block diagram of separating UEs in CDM based method for group common PUCCH, in accordance with an embodiment of the present invention. In the CDM based method of sharing the group common resources, Code Division Multiplexing (CDM) approach may be utilized. A PUCCH resource indicator may indicate the UE of N PRBs. Each UE may be preconfigured with a unique orthogonal sequence. The UE may generate the HARQ information bit corresponding to ACK or NACK. Further, the UE may modulate the HARQ information with a preconfigured modulation scheme and may transmit the HARQ information on the allocated N PRBs.

To reduce the signalling overhead of beam indication in Rel 17 for single TRP, unified TCI framework may be included. The unified TCI framework may utilize a single common beam to indicate the beam for different data, channels, or RSs. Rel 17 Unified TCI framework for single TRP may include both ‘joint TCI for DL and UL’ and ‘separate beam indication for UL and DL’ transmission or reception.

The BS may schedule the UE supporting the unified TCI framework and connected to multi TRP. This requires modifications to support the procedure to handle the collisions between data, channel, and RSs, TCI states indication of PDSCH and PDCCH etc.

A UE that is connected with multi TRP, may be scheduled to receive signals or channels simultaneously from both the TRPs using full or partially overlapping resources. If the UE is not capable of receiving with different spatial Rx filters simultaneously, then collision may occur. In Rel 17 NR, enhancements may be made for improving reliability of PDCCH in M-TRP scenario by repeating the PDCCH from all the TRPs. The enhancement may be achieved by linking the search space sets in which the PDCCHs that are being repeated and each of these linked search space sets mapped to a unique CORESET. A new method is proposed utilizing this enhancement, to determine a QCL assumption when a UE is configured to monitor multiple CORESETs with different unified TCI states at the same time instant and the search space sets in which the UE is monitoring PDCCH are linked for PDCCH repetition.

The UE may be scheduled to support unified TCI framework and connected to multi TRP. If the UE may search for PDCCH candidates in overlapping PDCCH monitoring occasions in multiple CORESETs that have been configured with same or different QCL-Type set to ‘typeD’ properties and if at least one of the overlapping PDCCH candidates belongs to a search space set that is configured for PDCCH repetition, then the UE selects one among the multiple overlapping CORESETs as described below and looks for PDCCH in all the CORESETs that has the same spatial Rx setting as the selected CORESET. The selected CORESET may be the CORESET corresponding to the CSS set with the lowest index in the cell with the lowest index containing CSS. On the contrary, the selected CORESET may be the CORESET corresponding either to the USS set with the lowest index in the cell with lowest index among all the overlapping USS sets configured with PDCCH repetition, or to the USS set with the lowest index in the cell with lowest index among all the overlapping USS sets configured without PDCCH repetition.

If the UE is configured to monitor multiple search space sets with different spatial settings at the same time instant, the UE may follow the spatial setting of the CSS set with lowest ID if present. If no CSS set is present in the overlapping search space sets, the UE may follow the spatial setting of the USS with lowest ID configured for PDCCH repetition. If no CSS set is present in the overlapping search space sets and if no USS set is present among the overlapping search space sets configured for PDCCH repetition, the UE may follow the spatial setting of the USS with the lowest ID.

Conflict resolution rules may be defined when the UE, which is not capable of receiving in fully/partially overlapping time resources with different spatial receiver filters, is scheduled to receive PDCCH and PDSCH in fully/partially overlapping time resources with different spatial receiver filters.

If there is an overlap between a PDSCH and a CORESET, rate-matching of the PDSCH around the overlapping CORESETs may be employed. For example, in NR, rate matching of PDSCH around the PDCCH region may be employed. However, rate matching necessitates that PDSCH and the overlapping CORESET belong to the same beam. In other words, both the PDSCH and CORESET should share the same QCL Type-D properties. Hence, to overcome such problem, the UE follows any one of dropping the PDSCH and searching for PDCCH in the overlapping CORESET, receiving the PDSCH and ignoring PDCCH in the overlapping CORESET, and monitoring PDCCH in the CORESET in the overlapped symbols and decoding PDSCH partially by receiving the PDSCH in the non-overlapped symbols.

In case of collision between RS and a PDSCH, the UE may follow one of dropping the PDSCH and decoding the RS, dropping the RS and decoding the PDSCH, and decoding the RS in the overlapped symbols and decoding PDSCH partially by receiving the PDSCH in the non-overlapped symbols.

In case of collision between CSI-RS from two TRPs, the UE may select the CSI-RS for which the measurement and reporting is critical, for example CSI-RS for beam management should be given priority over CSI-RS for CSI measurement.

If the UE is configured with M-TRP operation, there may exist situations where channel characteristics from one TRP changes, while the channel characteristics from another TRP remains unchanged. This leads to a requirement for the BS to change/update only one out of the two activated TCI states for M-TRP operation. A new signaling is proposed to handle such scenarios. In this method, configuration of unified TCI state to the UE may also comprise a field which indicates a TCI pool index. When the UE is connected with n number of TRPs, the field may have values ranging from 0 to n−1.

Consider the case of an UE connected to 2 TRPs. The TCI pool index takes values 0 and 1. Since there are two TRPs, a pair of TCI states are indicated to the UE in DCI. The TCI pool with index 0 (or 1) may be mapped to a first TCI indicated in DCI and TCI pool with index 1 (or 0) may be mapped to a second TCI indicated in the DCI. For example, if the activated pair of TCI states at the UE is (TCI 1, TCI 2) and if UE receives a DCI that signals a new TCI state (TCI 3) with TCI pool index 0 (or 1), then UE will update the active TCI states to (TCI 3, TCI 2) and if UE receives a DCI that signals a new TCI state (TCI 3) with TCI pool index 1 (or 0), then UE will update the active TCI states to (TCI 1, TCI 3).

The UE may be configured with up to 128 unified TCI states for joint/DL TCI state indication and 64 TCI states for UL TCI state indication. Further, the BS may signal a MAC-CE to the UE comprising up to eight code-points where each code point maps to either one joint TCI state in case of a UE is configured with joint unified TCI operation or one DL TCI state and one UL TCI state in case of a UE is configured with separate unified TCI operation.

When a Multi-TRP architecture may be combined with unified TCI framework, the BS may signal the unified TCI state for UL data/channel/RS and DL data/channel/RS for each TRP in case of separate and joint TCI indication to the UE using DCI. To signal the unified TCI state to a UE using DCI for each TRP for both the cases of separate TCI and joint TCI operation, code-points in MAC-CE should map to upto four TCI states.

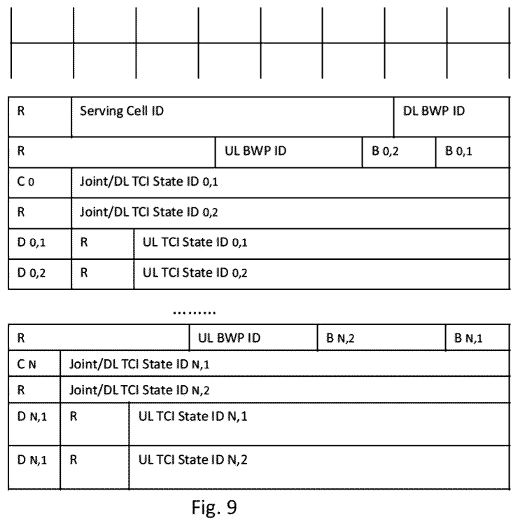

FIG. 9 illustrates a MAC-CE structure to support unified TCI framework for M-TRP operation, in accordance with an embodiment of the present invention. The MAC-CE structure may comprise at least one of Serving Cell ID, DL BWP ID, UL BWP ID, Ci, Joint/DL TCI state IDi,j, Bi,j, UL TCI state IDi,j, Dij, Bi, and R. Serving Cell ID indicates the identity of the Serving Cell for which the MAC-CE applies. DL BWP ID indicates a DL BWP for which the MAC-CE applies as the codepoint of the DCI bandwidth part indicator field as specified in TS 38.212. UL BWP ID indicates a UL BWP for which the MAC-CE applies as the codepoint of the DCI bandwidth part indicator field as specified in TS 38.212. Ci indicates whether the octet containing joint/DL TCI state IDi,2 is present. If this field is set to “1 (or 0)”, the octet containing TCI state IDi,2 is present. If this field is set to “0 (or 1)”, the octet containing TCI state IDi,2 is not present. Joint/DL TCI state IDi,j indicates one joint/DL unified TCI state configured for a UE out of the 128 Joint/DL TCI states configured for the UE. Bi,j indicates whether the octet containing UL TCI state IDi,j is present. If this field is set to “1 (or 0)”, the octet containing UL TCI state IDi,j is present. If this field is set to “0 (or 1)”, the octet containing UL TCI state IDi,j is not present. UL TCI state IDi,j indicates one UL unified TCI state configured for a UE out of the 64 UL TCI states configured for the UE. Dij indicates whether UE should consider the preceding octet as padding or as DL TCI state. Bi indicates AND operation of Bi,1, Bi,2. R indicates Reserved bit, set to “0”.

If the UE is configured with a set of 128 unified TCI states, one of these TCI states may be activated using a DCI for the UE. When the UE monitors any search space set, the UE may utilize the activated unified TCI state to receive the CORESET.

If the UE is configured to be operating in M-TRP framework and unified TCI simultaneously, the BS may activate a pair of unified TCI states to, support M-TRP operation. The UE may determine which one of the two TCI states to be used to receive PDCCH.

Consider the case of UE connected with 2 TRPs. If the UE is configured with two CORESET pool indices i.e. index ‘0 (or 1)’ and ‘1 (or 0)’ in RRC configuration, then each of the activated unified TCI states may be mapped to one CORESET pool index. The UE may determine the TCI state of a CORESET based on its associated CORESET pool index. For example, if a pair of unified TCI states (TCI state 1, TCI state 2) are activated for a UE and if TCI state 1 maps to CORESET pool index 1 and TCI state 2 maps to CORESET pool index 2, the UE may apply TCI state 1 for all the CORESETs with CORESET pool index 0 (or 1) and TCI state 2 for all the CORESETs with CORESET pool index 1 (or 0). After mapping a unified TCI state per CORESET pool index, the UE may monitor for PDCCH in a CORESET using the associated unified TCI state.

If the UE is configured with only one CORESET pool index and it is activated with two unified TCI states, the UE may utilize one of the following proposed methods for determining the active TCI state of a CORESET.

There may be two methods of determining of TCI state for the CORESET. In a first method, the UE may monitor all the CORESETs with the lowest TCI state index among the activated TCI states. In a second method, the UE may monitor all the CORESETs using the TCI state with the highest TCI state index among the activated TCI states.

The UE may utilize a mapping pattern for determining the TCI states of a CORESET that is being monitored in a slot. The mapping pattern may be a sequence of 1's and 2's of predefined length, where 1's represents TCI state 1 and 2's represents TCI state 2. Two different mapping patterns may be utilized for determining the TCI states. Two mapping patterns may be a sequential mapping pattern and a cyclic mapping pattern.

In sequential mapping pattern, the UE may be configured with a mapping pattern, for example [1 1 2 2]. Starting from the slot from which the pair of unified TCI states are activated, the UE may follow a pattern for determining the active TCI state of all the CORESETs that are configured to be monitored in that slot. In the example pattern shown above, in the first and second slots after which the pair of unified TCI states are activated, the UE may monitor all the CORESETs that are configured to be monitored using TCI state 1. In the third and fourth slots after which the pair of unified TCI states are activated, the UE may monitor all the CORESETs that a UE is configured to monitor using TCI state 2. This pattern is repeated for the later slots also. Alternatively, a different pattern such as [2 2 1 1] can also be configured.

In the cyclic mapping pattern, the UE may be configured with a mapping pattern, for example [1 2 1 2 . . . ]. Starting from the slot from which the pair of unified TCI states are activated, the UE may monitor all the CORESETs that are configured to be monitored in the odd slots using TCI state 1 and all the CORESETs that are configured to be monitored in the even slots using TCI state 2. The cyclic mapping pattern may be repeated for later slots also. Alternatively, a different pattern such as [2 1 2 1 . . . ] may also be used, where CORESETs configured in odd slots use TCI state 2 and CORESETs configured in even slots use TCI state 1.

The UE may associate a TCI state to a CORESET based on the CORESET index. For example, all the CORESETs with odd index will be associated with TCI state 1 and all the CORESETs with even index will be associated with TCI state 2 or alternatively CORESETs with even index will be associated with TCI state 1 and all the CORESETs with odd index will be associated with TCI state 2

There may have various M-TRP schemes that are introduced by 3GPP. In the case of a multi TRP scenario, the transmission and reception to and from different TRPs can be multiplexed in any one of time, frequency, and space, leading to FDM Scheme A, FDM scheme B, TDM scheme A, SDM scheme etc. To support the various M-TRP schemes as mentioned above, 3GPP introduced various new parameters configured to a UE. One among these parameters is a CORESETPoolIndex. A CORESET pool index is a variable that will be present inside the ControlResourceSet IE. This variable can take a value of either 0 or 1. If this variable is not configured for a CORESET, UE assumes default value that is 0 for that CORESET. When a UE is configured by higher layer parameter PDCCH-Config that contains two different values of CORESETPoolIndex in ControlResourceSet, the UE may expect to receive multiple PDCCHs scheduling fully/partially/non-overlapped PDSCHs in time and frequency domain. Similarly, when a UE is configured with 0 CORESETPoolIndex by higher layer parameter then the UE may expect to schedule with full/partially/non-overlapped PDSCHs in time and frequency domain, the full scheduling information for receiving a PDSCH is indicated and carried only by the corresponding PDCCH.

The various methods are proposed of how to determine the TCI state for PDSCH based on configured CORESET pool index in different scenarios such as the UE is scheduled to receive from single TRP alone, the UE is scheduled to receive form Multi TRP but with single DCI, and the UE is scheduled to receive from Multi TRP using multi DCI.

In a first scenario, the UE is configured with only one CORESET pool index. The procedure of how to determine the TCI state for PDSCH that is scheduled by various types of DCI viz., S-DCI, S-TRP DCI may be described. Here DCIs are categorized based on the type of PDSCH transmissions they are scheduling. The following notation of S-DCI, S-TRP DCI is used in this report. If a DCI schedules a M-TRP PDSCH with any of FDM scheme A, FDM scheme B, TDM scheme A, then this DCI is referred as S-DCI and if a DCI schedules a Single-TRP PDSCH, then it referred as S-TRP DCI.

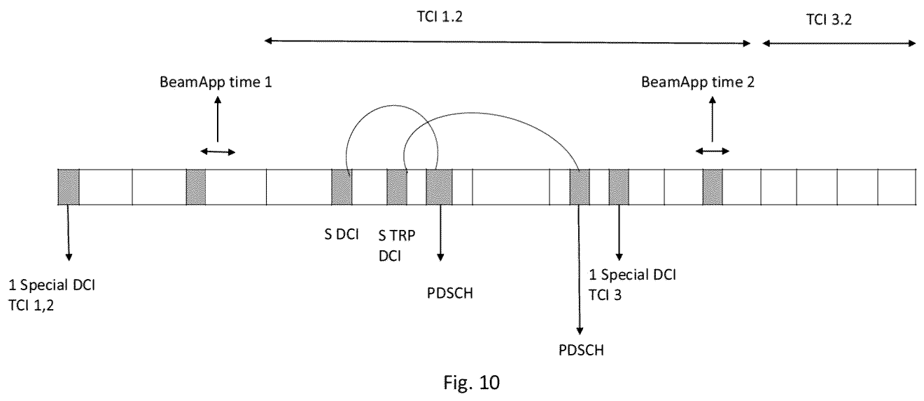

FIG. 10 illustrates a TCI indication for single TRP and single DCI multi TRP, in accordance with an embodiment of the present invention. The BS may activate two unified TCI states to enable M-TRP transmission to the UE using a DCI that carries two unified TCI states. The UE may activate the two unified TCI states from the slot which is at an offset of BeamApp time from the last symbol of the PUCCH corresponding to the DCI. For example, as illustrated in FIG. 10, the UE may receive a DCI that activates TCI states i,j in slot 1 and the corresponding PUCCH is transmitted on slot 2. The UE may activate the signalled TCI states i.e., TCI states i,j from the third slot which is the slot after BeamApp time after the last symbol of PUCCH.

The UE may differentiate whether it is scheduled to receive M-TRP PDSCH or S-TRP PDSCH based on the number of TCI states that are being signalled by the corresponding DCI. However, if the UE is configured with unified TCI states, then the UE can be scheduled with PDSCH without explicit indication of TCI states in the DCI due to special DCI signalled in case of unified TCI framework. If the UE receives a DCI without any explicit indication of TCI states, the UE may not be able to understand whether the DCI schedules M-TRP PDSCH or S-TRP PDSCH. In the proposed method, signalling schemes to indicate the UE whether the scheduled PDSCH is configured to receive with 1 TCI state (S-TRP PDSCH) or 2 TCI states (M-TRP PDSCH) as illustrated in FIG. 10. The proposed signalling schemes may have two types of indications, for example, an explicit Indication and an implicit indication. In the explicit indication, 1-bit field or group of bits of the DCI may be received by the UE. The bit filed may indicate whether the UE uses 1 or 2 TCI states for receiving the PDSCH. In the implicit indication, if the UE is configured to receive PDSCH with two CDM groups, the UE may utilize two TCI states for receiving PDSCH. If the UE is configured to receive PDSCH with one CDM group, the UE may utilize one TCI state for receiving PDSCH.

The UE may determine whether to receive a PDSCH using either TCI1 or TCI2 of the activated TCI states, as illustrated in FIG. 10. If the UE determines that it is scheduled to receive M-TRP PDSCH, the UE may utilize these two TCI states in a specific order. For example, if the UE is configured to receive a PDSCH with FDM scheme A, the UE may utilize TCI state 1 for receiving first PDSCH and TCI state 2 for receiving second PDSCH.

Similarly, TCIs indicated using special DCI such as TCI states 1 and 2 may be applied for other S-DCI M-TRP schemes. If the UE determines that it is scheduled to receive S-TRP PDSCH, the UE may follow one of the proposed four rules to determine which TCI state to use for receiving the PDSCH. In a first rule, the UE may utilize TCI state 1. In a second rule, the UE may utilize TCI state 2. In a third rule, the UE may utilizes TCI state with lowest ID. In a fourth rule, the UE may utilizes TCI state with highest ID.

The UE may receive the special DCIs with one or two TCI state indication. As shown in FIG. 10, one special DCI may activate TCI state 1 and 2 and other special DCI may activate only TCI state 3. Therefore, certain rules need to be proposed for updating the new activated TCIs with the old TCI state. In the proposed method, after the UE is activated with two unified TCI states i.e., TCI 1, TCI 2 to support M-TRP transmission, if a UE receives a DCI that activates two new unified TCI states, the UE may update the old TCI states with the new TCI states from the first slot after BeamApp time from the last symbol of the corresponding PUCCH. If the UE may receive a DCI that activates only one TCI state, the UE may follow one of the proposed rules. In a first rule the UE may discard the old TCI states and activates the new TCI state. In a second rule, the UE may replace TCI state 1 of the old TCI state with the new TCI state and activates the new pair. In a third rule, the UE may replace TCI state 2 of the old TCI state with the new TCI state and activates the new pair.

The UE may be configured with two CORESET pool indices. As per Rel-16 NR, if the UE is configured with two CORESET pool indices, the UE may receive any type of DCI i.e., M-DCI, S-DCI, and S-TRP DCI. A method to receive PDSCH by the UE when it is configured with two CORESET pool indices is described.

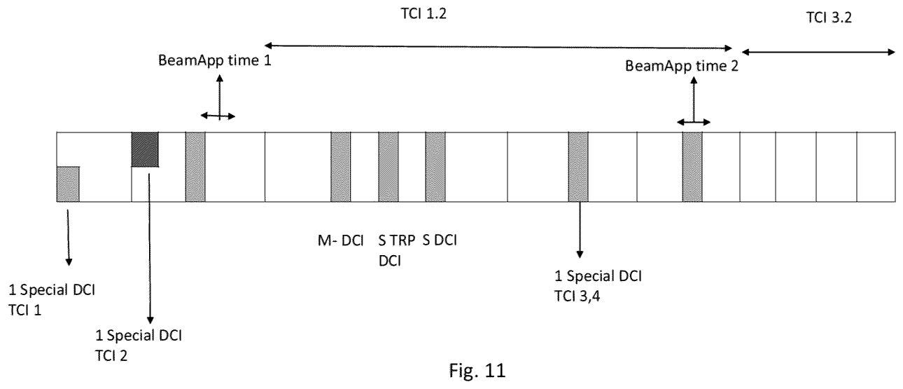

FIG. 11 illustrates a TCI indication for single TRP, single DCI multi TRP, and multi DCI MTRP, in accordance with an embodiment of the present invention. The BS may activate the UE with a pair of unified TCI states (TCI state 1, TCI state 2) using a DCI. The UE may activate the two TCI states after BeamApp time from the last symbol of the PUCCH corresponding to the DCI activating the TCI states. Each of the activated TCI state may be associated with a CORESET pool index. The UE may map a TCI state to the CORESET pool index as per the pre-defined rules. In a first pre-defined rule, the UE may map TCI state 1 with CORESET pool index 0, TCI state 2 with CORESET pool index 1. In a second pre-defined rule, the UE may map TCI state 1 to the CORESET pool index of the CORESET in which UE received the DCI activating the TCI states and UE maps TCI state 2 to the other CORESET pool index.

In another method, the BS may activate two TCI states for the UE using two separate DCI where each DCI is scheduled in a CORESET with a unique CORESET pool index. The UE may activate the corresponding TCI state signalled in the DCI from the first slot after the BeamApp time from the last symbol of the corresponding PUCCH. The UE may map the TCI state to the CORESET pool index comprising the CORESET in which the UE receives the DCI.

Hence, in both the methods described above, the UE may be activated with a pair of TCI states (TCI state 1, TCI state 2) and each of the TCI state is associated with a CORESET pool index. If a UE is scheduled with any of the M-TRP schemes, the UE may utilize the activated pair of TCI states accordingly.

For management of beam, it may be assumed that panels are located at different positions, for example, back-to-back, the UE may not be able to determine transmission beam on one panel for uplink transmission based on downlink measurement on the other panel, and vice versa, even it could do so for the same panel. To address this issue, associations between DL beams on one panel and UL beams on the other panel need to be trained, maintained at UE side. A movement, rotation, and blockage of the UE may lead to no beam correspondence across different UE panels which requires switching of the panels at UE side for power saving. To speed up panel selection, one solution is to support BS-initiated/controlled UE panel selection/activation. Performance-wise, it is preferable to turn on all UE panels, but it may be excessive in terms of power consumption. To support BS-initiated UE panel activation (instead of selection), proper balancing between performance and power consumption needs to be established.

Thus, switching of panels at UE side by the BS is described. The UE may be equipped with multiple panels and some of them are in active mode and some of them are in inactive mode to save power. Due to channel characteristics between the UE and the BS, there is a need to switch from one panel to other panel at the UE side for UL or DL transmission or reception. To switch panel at the UE side, the BS may configure panel ID to UE through one of the multiple options. In a first option, the BS may configure the panel ID associated with TCI ID through RRC signalling to the UE. Based on the received panel ID, the UE may switch the panel and may start the transmission and reception using activated panel with the BS. In a second option, to switch the panel at the UE side, the BS may signal the panel ID through DCI to activate the panel at the UE. In a third option, to switch the panel at the UE, the BS may transmit the panel ID though MAC-CE to activate the panel at the UE.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

1. A method of indicating transmission configuration indicator (TCI) state of operation for a user equipment (UE) in a telecommunication network, comprising:
receiving at least one medium access control-control element (MAC-CE) structure, wherein the at least one MAC-CE structure comprises at least one code-point mapped to at least one TCI state from a plurality of the TCI states, wherein the plurality of the TCI states is one of at least one of joint TCI state, downlink (DL) TCI state, uplink (UL) state and at least one of joint/DL TCI state, and UL state;
receiving a downlink control information (DCI), wherein the DCI comprises a TCI field indicating a code-point of the at least one MAC-CE structure and a flag for selection of one of joint TCI state of operation for both DL and UL and separate TCI states of operation one for DL and one for UL, wherein the flag comprises at least one bit;
activating the at least one TCI state from the plurality of TCI states, based on the flag and the TCI field; and
operating by the UE in the at least one TCI state.

2. The method as claimed in claim 1, wherein the at least one MAC-CE structure comprises at least one of bandwidth part (BWP) identity (ID), serving cell ID, and a code-point.

3. The method as claimed in claim 1, wherein at least one code-point is mapped to at least one TCI state.

4. The method as claimed in claim 3, wherein the at least one code-point is mapped to the at least one TCI state from at least one of joint/DL TCI states, joint TCI states, DL TCI states, and UL TCI states.

5. The method as claimed in claim 1, wherein the at least one code-point of the at least one MAC-CE structure is mapped to the at least one of one TCI state and two TCI states.

6. The method as claimed in claim 5, wherein the at least one MAC-CE structure indicates at least one of the joint TCI state operation and the separate TCI state operation.

7. The method as claimed in claim 5, wherein the at least one code-point in the at least one MAC-CE structure is mapped to the at least one TCI state from at least one of joint/DL TCI states and UL TCI states.

8. A method of indicating transmission configuration indicator (TCI) state operation for a user equipment (UE) in a telecommunication network, comprising:
receiving a medium access control-control element (MAC-CE) structure comprising at least one of bandwidth part (BWP) identity (ID), serving cell ID, at least one code-point, wherein the at least one code-point is mapped to at least one TCI state from the plurality of TCI states, and a flag for selection of one of joint TCI state of operation for both Downlink (DL) and Uplink (UL), and separate TCI states of operation one for DL and one for UL, wherein flag comprises at least one bit;
receiving a downlink control information (DCI) comprising a TCI field, wherein the TCI field indicates the at least one code-point of the MAC-CE structure;
activating the at least one TCI state from the plurality of TCI states based on the flag in the MAC-CE structure and the TCI field of the DCI; and
operating by the UE in the at least one TCI state.

9. The method as claimed in claim 8, wherein the plurality of the TCI states is at least one of joint/DL TCI state and UL state.

10. The method as claimed in claim 8, wherein the at least one code-point is mapped to the at least one TCI state from at least one of joint/DL TCI states and UL TCI states.

11. A method of communication in a telecommunication network, comprising:
transmitting, by a base station (BS), a group-common downlink control information (DCI) to an at least one user equipment (UE) from a plurality of UEs, wherein the group-common DCI comprises at least one transmission configuration indicator (TCI) state corresponding to the at least one UE and a scheduling information for a group-common physical uplink control channel (PUCCH); and
receiving by the BS, a hybrid automatic repeat request (HARQ) indicating the status of reception of the group-common DCI from the at least one UE in the group common PUCCH.

12. The method as claimed in claim 11, wherein the at least one TCI state in the group-common DCI is used by the at least one UE for at least one of transmission and reception.

13. The method as claimed in claim 11, wherein transmitting by the BS, further comprises configuring a common radio network temporary identifier (RNTI) to the at least one UE for receiving the group-common DCI.

14. The method as claimed in claim 11, wherein the at least one TCI state is indicated in the group-common DCI, using a bit field from the plurality of bit fields to indicate the at least one TCI state for the at least one UE, wherein the position of the bit field of the at least one UE is configured by the BS.

15. The method as claimed in claim 14, wherein the at least one TCI state is configured by the BS from a plurality of TCI states of the at least one UE.

16. The method as claimed in claim 11, wherein the at least one TCI state is configured by the BS from a plurality of TCI states of the at least one UEs, wherein the plurality of the TCI states of the at least one UE is preconfigured with at least one common plurality of the TCI state.

17. The method as claimed in claim 11, wherein the scheduling information comprises a timing offset indicating a slot index and a PUCCH resource indicator for the group-common PUCCH.

18. The method as claimed in claim 17, wherein the PUCCH resource indicator indicates at least one of time domain resource allocation, frequency domain resource allocation, a modulation order, and a coding rate of the group-common PUCCH.

19. The method as claimed in claim 11, wherein the HARQ of the at least one UE is received in a subset of resources allocated for the group-common PUCCH.

20. The method as claimed in claim 19, wherein the subset of resources of the at least one UE are multiplexed in at least one of time domain, frequency domain, spatial domain, and code domain.

21. The method as claimed in claim 19, wherein the HARQ of the at least one UE is indicated using at least one bit.

22. The method as claimed in claim 21, wherein the at least one UE encodes and modulates the at least one bit to obtain modulated symbols.

23. The method as claimed in claim 22, wherein the modulated symbols are multiplied with a preconfigured sequence.

24. The method as claimed in claim 21, wherein the at least one UE maps the at least one bit to a preconfigured sequence.

25. A method of determining at least one control resource set (CORESET) and at least one search space set for monitoring physical downlink control channel (PDCCH) in multi-transmission/reception point (TRP) system, the method comprising:
receiving a configuration information from a base station (BS) by at least one UE to monitor, at least one PDCCH, in a plurality of CORESETs configured with different quasi-co-location (QCL) properties and a plurality of search space sets associated with at least one CORESET from the plurality of CORESETs, at the same time instant, wherein the at least one search space set of the plurality of search space sets is linked with PDCCH repetition;
determining, by the at least one UE, a first CORESET from the plurality of CORESETs;
determining, by the at least one UE, an at least one second CORESET based on the QCL properties of the first CORESET;
monitoring, by the at least one UE, the at least one PDCCH in the at least one search space set associated with the first CORESET; and
monitoring, by the at least one UE, the at least one PDCCH in the at least one search space set associated with at least one second CORESET.

26. The method as claimed in claim 25, wherein the first CORESET is associated with one of a combined search space (CSS) and unified search space (USS) of lowest index.

27. The method as claimed in claim 25, wherein the first CORESET is associated with one of a CSS and USS of lowest index configured with the PDCCH repetition.

28. The method as claimed in claim 25, wherein the first CORESET is associated with one of a CSS and a USS of lowest Identity (ID) configured with spatial receive parameters in the QCL properties.

29. The method as claimed in claim 25, wherein the first CORESET is associated with one of a CSS and a USS of lowest ID configured with spatial receive parameters in the QCL properties and for the PDCCH repetition.

30. The method as claimed in claim 25, wherein the QCL properties comprise at least one of a delay spread, a doppler spread, an average delay, a doppler shift, an average gain, and spatial receive parameters.

31. The method as claimed in claim 25, wherein the QCL properties are configured for the plurality of CORESETs belonging to a unified TCI state.

32. A method of receiving at least one of at least one physical downlink shared channel (PDSCH) and at least one physical downlink control channel (PDCCH) in multi-transmission/reception point (TRP) system, the method comprising
receiving, by at least one user equipment (UE), a configuration information from a base station (BS) to monitor PDCCH in a plurality of control resource sets CORESETs configured with quasi-co-location (QCL) properties;
receiving, by at least one UE, a scheduling information from the BS for at least one PDSCH and corresponding QCL properties;
determining, by the at least one UE, at least one CORESET to monitor and at least one scheduled PDSCH are overlapping one of fully and partially in time and has different QCL properties; and
determining, by the at least one UE, to perform at least one of PDCCH monitoring in at least one CORESET and receive at least one PDSCH based on preconfigured rules.

33. The method as claimed in claim 32, wherein the preconfigured rules specify the at least one UE to perform PDCCH monitoring in the at least one CORESET and drop the at least one PDSCH.

34. The method as claimed in claim 32, wherein the preconfigured rules specify the at least one UE to receive the at least one PDSCH and skip PDCCH monitoring in the at least one CORESET.

35. The method as claimed in claim 32, wherein the preconfigured rules specify the at least one UE to perform PDCCH monitoring in the at least one CORESET and to receive the at least one PDSCH in symbols not overlapping with the at least one CORESET.

36. A method of receiving at least one physical downlink shared channel (PDSCH) and at least one reference signal (RS) in multi-transmission/reception point (TRP) system, the method comprising:
receiving a configuration information by at least one user equipment (UE) to receive at least one RS configured with quasi-co-location (QCL) properties;
receiving, by the at least one UE, from a base station (BS), scheduling information for at least one PDSCH, indicating the corresponding QCL properties;
determining, by the at least one UE, that the at least one RS and the at least one PDSCH are overlapping one of fully and partially in time with different QCL properties; and
receiving, by the at least one UE, at least one of the at least one RS and the at least one PDSCH based on preconfigured rules.

37. The method as claimed in claim 36, wherein the preconfigured rules specify the at least one UE to receive the at least one RS and drop the at least one PDSCH.

38. The method as claimed in claim 36, wherein the preconfigured rules specify the at least one UE to receive the at least one PDSCH and drop the at least one RS.

39. The method as claimed in claim 36, wherein the preconfigured rules specify the at least one UE to receive the at least one RS and to receive the at least one PDSCH in the symbols not overlapping with the at least one RS.

40. A method of receiving at least one reference signal (RS) in multi-transmission/reception point (TRP) system, the method comprising:
receiving a configuration information by an at least one user equipment (UE) to receive a plurality of RSs configured with quasi-co-location (QCL) properties;
receiving, by the at least one UE, a preconfigured priority corresponding to each RS from the plurality of RSs;
determining, by the at least one UE, that at least one first RS and at least one second RS of the plurality of RSs are overlapping one of fully and partially in time with different QCL properties; and
receiving, by the at least one UE, the at least one first RS and the at least one second RS based on the preconfigured priority of the corresponding RS.

41. The method as claimed in claim 40, wherein the at least one RS is channel state information RS (CSI-RS).

42. The method as claimed in claim 41, wherein a priority of CSI-RS used for beam management is higher than a priority of CSI-RS used for CSI measurement.

43. A method of updating at least one transmission configuration indicator (TCI) state of at least one user equipment (UE) in a multi-transmission/reception point (TRP) system, the method comprising:
transmitting, by a base station (BS), configuration information associated with a plurality of TCI states to at least one UE, wherein the configuration information comprises a TCI pool index corresponding to the plurality of TCI states;
signaling, by the BS to the at least one UE, at least one set of TCI states from the pre-configured list of TCI states;
performing, by the at least one UE, at least one of transmission and reception using the at least one set of TCI states; and
signaling, by the BS, to obtain an updated TCI states by replacing the at least one TCI state with at least one another TCI state, wherein the at least one TCI state is replaced based on the TCI pool index of the at least one another TCI state.

44. The method as claimed in claim 43, further comprising performing, by the at least one UE, at least one of transmission and reception using the updated TCI states.

45. The method as claimed in claim 43, wherein the configuration information is signalled using at least one of radio resource control (RRC) and medium access control-control element (MAC-CE) based signalling.

46. The method as claimed in claim 43, wherein a value of the TCI pool index ranges from 0 to n−1, and wherein ‘n’ indicates a number of TRPs connected with the at least one UE.

47. The method as claimed in claim 43, wherein the at least one set of TCI states is a pair of TCI states indicated to the UE for at least one of transmission and reception.

48. The method as claimed in claim 43, wherein the at least one UE updates the at least one TCI state by replacing the at least one TCI state in the at least one set of TCI states belonging to the same TCI pool index as the at least one another TCI state.

49. The method as claimed in claim 43, wherein the at least one TCI state comprises at least one quasi-co-location (QCL) property, wherein the at least one QCL property includes at least one of a delay spread, a doppler spread, an average delay, a doppler shift, an average gain, and spatial receiver parameters.

50. The method as claimed in claim 43, wherein the at least one TCI state is signalled using a downlink control information (DCI).

51. The method as claimed in claim 43, wherein the at least one TCI state belongs to a unified TCI state.

52. A method of receiving an at least one transmission configuration indicator (TCI) state for operation of at least one user equipment (UE) in a multi-transmission/reception point (TRP) system, the method comprising:
receiving a medium access control-control element (MAC-CE) structure comprising at least one code-point, wherein the at least one code-point is mapped to at least one TCI state from a plurality of TCI states of at least one TRP from the plurality of the TRPs, wherein the plurality of the TCI states is at least one of joint/DL TCI states and UL states;
receiving a downlink control information (DCI), wherein the DCI comprises a TCI field indicating one of the code-points from the MAC-CE structure;
activating at least one TCI state using the at least one code-point; and
operating by the at least one UE in the at least one TCI state.

53. The method as claimed in claim 52, wherein the at least one TCI state belongs to a unified TCI state.

54. The method as claimed in claim 52, wherein the MAC-CE structure comprises at least one of a serving cell Identity (ID), a downlink (DL) bandwidth part (BWP) ID, an uplink (UL) BWP ID, Ci, joint/DL TCI state ID, Bij, UL TCI state ID, Dij, and a reserved bit, where Ci indicates whether the octet containing joint/DL TCI state ID_{i,2} is present in the MAC-CE structure, Bij indicates whether the octet containing UL TCI state ID_{i,j} is present in the MAC-CE structure, and Dij indicates whether UE should consider the preceding octet as padding or as DL TCI state.

55. A method in a wireless communication system, the method comprising:
receiving, by at least one user equipment (UE) from a base station (BS), a configuration information associated with a plurality of transmission control indicator (TCI) states, wherein the configuration information comprises a panel index corresponding to the plurality of TCI states;
receiving, by the at least one UE, a panel ID from the configuration information, wherein the panel ID indicates position of an antenna panel from plurality of antenna panels of the at least one UE; and
beamforming, by the at least one UE, by activating the antenna panel for at least one of transmission and reception.

56. The method as claimed in claim 55, wherein the configuration information is received by the at least one UE using at least one of radio resource control (RRC) signaling, medium access control-control element (MAC-CE), and downlink control information (DCI).

57. A method of determining a unified transmission control indicator (TCI) state for monitoring a control resource set (CORESET) in a multi-transmission/reception point (TRP) system, the method comprising:
receiving, by at least one user equipment (UE), from a base station (BS), a configuration information associated with a plurality of unified TCI states and configuration information associated with a plurality of CORESETs, wherein each CORESET is associated with a CORESET pool index;
receiving, by the at least one UE, the activation information of plurality of unified TCI states;
determining, by the at least one UE, a unified TCI state from the plurality of TCI states for monitoring at least one CORESET of the plurality of CORESETs, based on associated CORESET pool index of the CORESET; and
receiving, by the at least one UE, an at least one physical downlink control channel (PDCCH) in the at least one CORESET using the determined unified TCI state.

58. The method as claimed in claim 57, wherein the activation of the plurality of unified TCI states is signaled using at least one of medium access control-control element (MAC-CE) and downlink control information (DCI).

59. The method as claimed in claim 57, wherein the plurality of CORESETs is divided into at least two sets, wherein the at least two sets are assigned to CORESET pool indices.

60. The method as claimed in claim 57, wherein the BS activates ‘n’ number of unified TCI states for the at least one UE, wherein ‘n’ indicates a number of TRPs connected with the at least one UE.

61. The method as claimed in claim 59, wherein the CORESET pool index ranges from 0 to n−1, wherein each CORESET pool index is associated with at least one TCI state of the plurality of activated TCI states.

62. The method as claimed in claim 61, wherein the at least one UE determines the TCI state of CORESETs with a CORESET pool index, as an activated TCI state associated with the CORESET pool index.

63. The method as claimed in claim 57, wherein the unified TCI state comprises a plurality of quasi-co-location (QCL) properties, and wherein the plurality of QCL properties include at least one of delay spread, doppler spread, average delay, doppler shift, average gain, and spatial receiver parameters.

64. A method of determining a unified transmission control indicator (TCI) state for monitoring a control resource set (CORESET) in a multi-transmission/reception point (TRP) system, the method comprising:
receiving, by at least one user equipment (UE), a configuration information associated with a plurality of unified TCI states, wherein the configuration information comprises a TCI state index associated with at least one unified TCI state of the plurality of unified TCI states;
receiving, by the at least one UE, a configuration information associated with a plurality of CORESETs, wherein the configuration information comprises a CORESET index associated with at least one CORESET of the plurality of CORESETs;
receiving, by the at least one UE, a pre-defined mapping pattern;
receiving by the at least one UE, activation of at least one TCI state of the plurality of TCI states from the BS;
determining, by the at least one UE, index of a slot from which the at least one unified TCI state is activated;
determining, by the at least one UE, a unified TCI state from the at least one unified TCI state for at least one CORESET, based on at least one of the CORESET index, the pre-defined mapping pattern, the slot index, and TCI state indices of the at least one unified TCI state; and
receiving, by the at least one UE, at least one physical downlink control channel (PDCCH) in the at least one CORESET using the unified TCI state.

65. The method as claimed in claim 64, wherein the at least one UE determines the unified TCI state of at least one CORESET as the TCI state with one of a lowest and a highest TCI state index.

66. The method as claimed in claim 64, wherein a slot is associated with the index of one of the integers from the sequence of integers in the pre-defined mapping pattern.

67. The method as claimed in claim 66, wherein the pre-defined mapping pattern comprises a sequence of integers, wherein each integer of the sequence of integers is associated with corresponding a TCI state of the at least one TCI states.

68. The method as claimed in claim 66, wherein the TCI state of the at least one CORESET in the slot is determined based on the TCI state associated with the integer of the sequence of integers associated with the slot.

69. The method as claimed in claim 64, wherein the pre-defined mapping pattern is one of a sequential mapping pattern and a cyclic mapping pattern.

70. The method as claimed in claim 64, wherein the at least one UE determines the TCI state of the at least one CORESET based on the CORESET index.

71. The method as claimed in claim 70, wherein two TCI states are activated to the at least one UE, and the at least one UE determines the TCI state of the CORESETs with even and odd CORESET index from the at least one TCI state.

72. A method of determining at least one unified transmission control indicator (TCI) state of at least one physical downlink shared channel (PDSCH) in a multi-transmission/reception point (TRP) system, the method comprising:
receiving, by the at least one user equipment (UE) from a Base Station (BS), a configuration information associated with a plurality of unified TCI states, wherein the configuration information comprises a TCI state index associated with the at least one unified TCI state of the plurality of TCI states;
receiving, by the at least one UE from the BS, a configuration information associated with a plurality of control resource sets (CORESETs);
receiving, by at least one UE from the BS using a first downlink control information (DCI), at least one unified TCI state of the plurality of TCI states, wherein the at least one unified TCI state is associated with a TCI state Identity (ID);
receiving, by the at least one UE from the BS, the scheduling DCI for the at least one PDSCH;
determining, by the at least one UE, the at least one unified TCI state for receiving the at least one PDSCH based on a TCI state index of at least one unified TCI state and the associated TCI state ID of the at least one unified TCI states; and
receiving, by the at least one UE, the at least one PDSCH using the at least one unified TCI state.

73. The method as claimed in claim 72, wherein the TCI state index is indicated to the at least one UE using radio resource control (RRC) message.

74. The method as claimed in claim 72, further comprising:
receiving, by the at least one UE, a second DCI indicating one unified TCI state; and
updating, by the at least one UE, at least one activated unified TCI states based on at least one of the unified TCI state in the second DCI and TCI state IDs of the activated unified TCI states in the first DCI.

75. The method as claimed in claim 72, wherein the at least one UE determines one of using one unified TCI states and the plurality of unified TCI states from the at least one unified TCI state, for receiving the at least one PDSCH based on a field in the scheduling DCI.

76. The method as claimed in claim 72, wherein the at least one UE determines one of using one unified TCI states and the plurality of unified TCI states from the at least one unified TCI state, for receiving the at least one PDSCH based on a number of code division multiplexing (CDM) groups present in the scheduling DCI.

77. The method as claimed in claim 75, wherein the field in the scheduling DCI comprises at least one bit.

78. The method as claimed in claim 76, wherein a scheduling DCI with only one CDM group indicates the at least one UE to use only one unified TCI state from the activated unified TCI states, for receiving the at least one PDSCH.

79. The method as claimed in claim 76, wherein a scheduling DCI with a plurality of CDM groups indicates the at least one UE to use the plurality of unified TCI states from the activated unified TCI states, for receiving the at least one PDSCH.

80. The method as claimed in claim 72, wherein the at least one UE determines a unified TCI state from the activated unified TCI states based on at least one of the TCI index of the activated unified TCI states and TCI IDs of the activated unified TCI states.

81. The method as claimed in claim 80, wherein the at least one UE determines the unified TCI state with one of a lowest and a highest associated TCI IDs of the activated unified TCI states.

82. The method as claimed in claim 80, wherein the at least one UE determines the unified TCI state with a one of lowest and highest TCI Index among the associated TCI indices of the activated unified TCI states.

83. The method as claimed in claim 74, wherein the at least one UE updates the activated TCI states by activating the unified TCI state indicated by the second DCI and discarding the activated TCI states indicated by the first DCI.

84. The method as claimed in claim 74, wherein the at least one UE updates the activated TCI states by replacing one of the activated TCI states indicated by the first DCI with the unified TCI state indicated by the second DCI, based on the associated TCI state IDs of the activated TCI states in the first DCI.

85. The method as claimed in claim 72, wherein each of the activated TCI states indicated by the first DCI is associated with a TCI state ID in incremental order starting from ‘1’.

86. The method as claimed in claim 72, wherein the configuration information associated with at least one CORESET from the plurality of CORESETs comprises a CORESET pool index.

87. The method as claimed in claim 86, wherein the CORESET pool index of the plurality of CORESETs are same.

88. A method of determining a unified transmission control indicator (TCI) state of at least one physical downlink shared channel (PDSCH) in a multi-transmission/reception point (TRP) system, the method comprising:
receiving, by at least one user equipment (UE) from a Base Station (BS), a configuration information associated with a plurality of unified TCI states, wherein the configuration information comprises a TCI state index associated with each unified TCI state;
receiving, by at least one UE from the BS, a configuration information associated with a plurality of control resource sets (CORESETs), wherein the configuration information comprises at least one of CORESET index and a CORESET pool index associated with at least one of CORESET of the plurality of CORESETs, wherein the CORESET pool index is at least one of ‘0’ and ‘1’;
receiving, by an at least one UE, an at least one downlink control information (DCI) from the BS for activating the two unified TCI states;
activating, by the at least one UE, the two unified TCI states;
mapping, by the at least one UE, the two activated unified TCI states to CORESET pool indices;
receiving, by an at least one UE, an at least one scheduling DCI, from the BS, for at least one PDSCH;
determining, by the at least one UE, at least one unified TCI state from the activated TCI states for receiving the at least one PDSCH based on a mapping rule between the unified TCI states and the CORESET pool indices; and
receiving, by the at least one UE, the at least one PDSCH using the at least one unified TCI state.

89. The method as claimed in claim 88, wherein the at least one UE maps a first TCI state of the two activated TCI states to at least one of CORESET pool index of ‘0’ and CORESET pool index of ‘1’, and a second TCI state of the two activated TCI states to an at least one of CORESET pool index of ‘1’ and CORESET pool index of ‘0’.

90. The method as claimed in claim 88, wherein the at least one UE maps a first TCI state of the two activated TCI states to a CORESET pool index of the CORESET in which the DCI is scheduled and a second TCI state of the two activated TCI states to the other CORESET pool index.

91. A method of determining a unified transmission control indicator (TCI) state of at least one physical downlink shared channel (PDSCH) in a multi-transmission/reception point (TRP) system, the method comprising:
receiving, by at least one user equipment (UE) from a base station (BS), a configuration information associated with a plurality of unified TCI states, wherein the configuration information comprises a TCI state index associated with each unified TCI state of the plurality of unified TCI states;
receiving, by the at least one UE from the BS, a configuration information associated with a plurality of control resource sets (CORESETs), wherein the configuration information comprises at least one of a CORESET index and a CORESET pool index associated with each CORESET, wherein the CORESET pool index is at least one of ‘0’ and ‘1’;
receiving by the at least one UE, an at least one downlink control information (DCI) from the BS for activating a unified TCI state of the plurality of unified TCI states, wherein the at least one DCI is scheduled in a CORESET with at least one of CORESET pool index of ‘0’ and ‘1’;
activating, by the at least one UE, the unified TCI state;
determining, by the at least one UE, at least one unified TCI state as the unified TCI state activated by the at least one DCI;
receiving by the at least one UE from the BS, at least one scheduling DCI, for at least one PDSCH; and
receiving, by the at least one UE, the at least one PDSCH using the determined at least one unified TCI state.
